(19) United States
(12) Patent Application Publication
(10) Pub. No.: US 2013/0204398 A1
(43) Pub. Date: Aug. 8, 2013

(54) ACCESS CONTROL DEVICE, ACCESS CONTROL SYSTEM, ACCESS CONTROL METHOD, AND COMPUTER READABLE MEDIUM

(71) Applicants: Takeaki Minamizawa, Tokyo (JP); Yuki Toyoda, Tokyo (JP)

(72) Inventors: Takeaki Minamizawa, Tokyo (JP); Yuki Toyoda, Tokyo (JP)

(73) Assignee: NEC CORPORATION, Tokyo (JP)

(21) Appl. No.: 13/877,117

(22) PCT Filed: Sep. 15, 2011
(86) PCT No.: PCT/JP2011/071749

§ 371 Date: Mar. 29, 2013

(30) Foreign Application Priority Data
Oct. 4, 2010 (JP) 2010-224508

(51) Int. Cl. G05B 11/01

(52) U.S. Cl. CPC G05B 11/01
USPC 700/11

(57) ABSTRACT

The present invention controls access to information so that the burden upon the owner of the information is reduced.

The access control device of the present invention includes a relationship information generation unit for generating relationship information including relationship among users on the basis of object information related to a first user and object information related to a second user, a relationship storage unit for storing the relationship information, and an access assessment unit for assessing the control state of access requested to the second user from the first user on the basis of the relationship information stored by the relationship storage unit.

### FIELD OF THE INVENTION

The present invention relates to access control between devices, and particularly to an access control device which manages the access control.

### BACKGROUND OF THE INVENTION

An information processing device like a computer connects with a network like the internet or a bus and communicates.

A device which is subject to access by connecting with such a network or a bus needs to secure safety or operability. Therefore, the device controls access from a request device which requests a connection (access) to the device (for example, refer to patent document 1). With respect to setting of control contents in such access control (hereinafter, just referred to as setting of access control), generally, an administrator of the device which is subject to access directly operates the device of access target.

However, when the network becomes large in size and complicated, the device of access target to which the setting of access control is performed is decentralized in a plurality of locations. For this reason, direct operation of the device of access target becomes difficult for the administrator who manages setting to a plurality of devices. Therefore, it is necessary for the administrator to make the setting of access control adapt to the network, and to perform the setting of access control of the device of access target by remote control operation (for example, refer to patent document 2 or patent document 3).

In this way, the administrator can set the access control of device via the network. However, even in this case, for the access control of the device of access target, the administrator needs to perform the setting for each device which has requested the access. Accordingly, when a user of the device which requests access desires access newly to the device which is subject to access, the user of the device which requests access makes contact with an owner or the administrator of the device which is subject to access. Then, the administrator who has received the notification sets the access control by remote control operation (for example, refer to patent document 4).

Further, in order to use in description of the best exemplary embodiment of the present invention, patent documents 5 to 7 relating to relationship are indicated.
[Patent document 1] Japanese Patent Application Laid-Open No. 2008-226058
[Patent document 2] Japanese Patent Application Laid-Open No. 2008-117007
[Patent document 3] Japanese Patent Application Laid-Open No. 2009-187107
[Patent document 4] Japanese Patent Application Laid-Open No. 2005-311462
[Patent document 5] Japanese Patent Application Laid-Open No. 2008-071112
[Patent document 6] Japanese Patent Application Laid-Open No. 2008-225089
[Patent document 7] Japanese Patent Application Laid-Open No. 2010-044448

### SUMMARY OF THE INVENTION

### Problems to be Solved by the Invention

However, in the access control described in patent document 4, the owner or the administrator of the device of access target needs to perform the setting of access control whenever a new access request occurs. Accordingly, there was a problem that a burden on device management increased.

The object of the present invention is to provide the access control which solves the above-mentioned problem and reduces a burden on the owner or the administrator of the device of access target.

### Means for Solving the Problem

An access control device of the present invention includes a relationship information generation unit which generates relationship information, based on object information relating to a first user and the object information relating to a second user, including relationship between said users, a relationship storage unit which stores said relationship information, and an access assessment unit which assesses a control state of access requested to said second user from said first user based on said relationship information which said relationship storage unit stores.

An access control system of the present invention includes an access control device, which includes a relationship information generation unit which generates relationship information, based on object information relating to a first user and the object information relating to a second user, including relationship between said users, a relationship storage unit which stores said relationship information, and an access assessment unit which assesses a control state of access requested to said second user from said first user based on said relationship information which said relationship storage unit stores, a reception device which is subject to request of access and operated by said second user, a request device which transmits the request of access of said first user, a reception device which is subject to access to the second user requested from said first user, and a network which connects said each device.

An access control method of the present invention generates relationship information, based on object information relating to a first user and the object information relating to a second user, including relationship between said users, and assesses a control state of access requested to said second user from said first user based on said relationship information.

An access control program of the present invention causes a computer to execute processing which generates relationship information, based on object information relating to a first user and the object information relating to a second user, including relationship between said users, and processing which assesses a control state of access requested to said second user from said first user based on said relationship information.

### Effect of the Invention

Based on the present invention, it can perform the access control which reduced a burden on the owner or the administrator of the device which is subject to access.

### BRIEF DESCRIPTION OF THE DRAWINGS

FIG. 1 A block diagram showing an example of an access control system according to a first exemplary embodiment of the present invention.

FIG. 2 A block diagram showing an example of an access control device according to the first exemplary embodiment.

FIG. 3 A sequence diagram showing an example of operation of the access control system according to the first exemplary embodiment.

FIG. 4 A figure showing an example of object information according to the first exemplary embodiment.

FIG. 5 A figure showing an example of relationship information according to the first exemplary embodiment.

FIG. 6 A flowchart showing an example of operation of the access control device according to the first exemplary embodiment.

FIG. 7 A block diagram showing a different example of the access control device according to the first exemplary embodiment.

FIG. 8 A block diagram showing an example of an access control system according to a second exemplary embodiment.

FIG. 9 A block diagram showing an example of an access control device according to the second exemplary embodiment.

FIG. 10 A figure showing an example of a policy according to the second exemplary embodiment.

FIG. 11 A sequence diagram showing an example of operation of the access control system according to the second exemplary embodiment.

FIG. 12 A flowchart showing an example of operation of the access control device according to the second exemplary embodiment.

FIG. 13 A sequence diagram showing an example of different operation of the access control system according to the second exemplary embodiment.

FIG. 14 A sequence diagram showing an example of different operation of the access control system according to the second exemplary embodiment.

FIG. 15 A sequence diagram showing an example of different operation of the access control system according to the second exemplary embodiment.

FIG. 16 A block diagram showing an example of an access control device according to a third exemplary embodiment.

FIG. 17 A figure showing an example of assurance information according to the third exemplary embodiment.

FIG. 18 A block diagram showing an example of an access control device according to a fourth exemplary embodiment.

FIG. 19 A figure showing an example of an address correspondence table according to the fourth exemplary embodiment.

FIG. 20 A block diagram showing an example of an access control device according to a fifth exemplary embodiment.

FIG. 21 A block diagram showing an example of an access control system according to a sixth exemplary embodiment.

FIG. 22 A block diagram showing an example of an access control device according to the sixth exemplary embodiment.

### EXEMPLARY EMBODIMENT OF THE INVENTION

Next, the exemplary embodiments of the present invention will be described with reference to drawings.

First, terminology used in the description according to the exemplary embodiments of the present invention will be outlined.

“User” is a person who uses the access control system according to the present exemplary embodiment. The user includes “reception person” and “requester” which will be described later.

“Access” is connection (access) with a predetermined device. And, the access of the exemplary embodiment according to the present invention includes access of device which is based on an instruction or operation of the user who operates or possesses the device. Further, although actually the device accesses in this way, the access of device based on the user's instruction is called “user's access” in the present exemplary embodiment. For example, when a first user requests access by operating a device to the device which a second user operates, it is called a request of access to the second user from the first user in the present exemplary embodiment. And, access to a user's device may be called access to user. Further, a logical case is described as this connection (access) in the description of the present exemplary embodiment, however, it does not mean that a physical connection is excluded.

“Access control” is control of access to a device, in other words, it is control of permission or non-permission (permission/refusal: access propriety) of connection (access). In the present exemplary embodiment, the logical access control is described, however, it does not mean that the physical access control is excluded. Further, the access control according to the present exemplary embodiment is not limited to assessment of permission or non-permission (permission/non-permission: access propriety) of access, but may include assessment and setting of the type of access (voice termination, mail arrival, file sending and data request). And, there may be a case where these are collectively called “control state of access”. Further, “access control” in the description according to the present exemplary embodiment will describe about, as an example of access control, the access control which notifies the device which is an access request source or an access request destination of permission or non-permission of access. However, the access control according to the present exemplary embodiment is not limited to this. For example, the access control according to the present exemplary embodiment may perform control with dividing into the type of access (information transmission, reception, transmission and reception). Moreover, the access control according to the present exemplary embodiment is not only limited to control of the device which exchanges information, but also it may be the access control which controls a relaying device (for example, a router) provided between devices. And, the access control according to the present exemplary embodiment is not only limited to one to one connection of devices, but also it may be control of permission or non-permission of participation in a network in which a plurality of devices are connected like V-LAN (Virtual Local Area Network).

“Reception device” is a device which is a target destination of access request. And, a person who possesses, operates or manages the reception device is called “reception person”.

“Request device” is a device which requests access to “reception device”. And, a person who performs an access request with operating or managing the request device is called “requester”.

“Policy” is a policy which “reception person” has decided for access control of “reception device”. “Policy” according to the present exemplary embodiment includes “policy” for performing assessment with using “relationship information” which will be described next. Further, “policy” may be held as data in a device which performs access control. Alternatively, “policy” is held by a different device from the device which performs access control, and the device which performs access control may retrieve it as necessary.

“Relationship” is the characteristic that indicates relations between “reception person” and “requester”. “Relationship” may be simply represented by “related” or “not related”, or may be expressed using “the degree of relation” which represents the degree (or the magnitude) of the relationship. And, “relationship” can be expressed using the type. The type of relationship is, for example, “subject” which was photographed in one photograph (for example, refer to patent documents 5 to 7), “coactor” who appeared on one play, or “coauthor” who wrote one book. The access control according to the present exemplary embodiment employs such relationship as an example of the description. And, the relationship may include information which indicates the human relations between “reception person” and “requester” (for example, “friend”, “acquaintance”, “relevant person on business”). Further, for efficiency of processing in a system or a device, the relationship may be processed or stored as information on the relationship between “reception device” and “request device” by simplifying the relations between “reception person” and “requester”.

“Relationship information” is information which includes the relationship to be used for access control. The relationship information is generated based on object information indicated next.

“Object” is about something general, however, in the present exemplary embodiment, it is supposed that it is a thing which includes the information which becomes the base for obtaining relationship (for example, a photograph or a brochure) or electronic information (for example, photograph data stored as an electronic file, or electronic data of brochure). And, for a purpose of extracting the relationship information, information in which necessary information such as a trust level that will be described later is added to the information which has been extracted from the information related to the object is called “object information”.

Further, the above-mentioned information related to the object that becomes a part of the object information will also be called “information related to an object” at below. Further, for judgment of relationship, the object may include a trust level described next. And, a provider of “information related to an object” may just be called a provider of “object information”.

“Trust level” is a scale which represents the degree of trust of “object (object information)” that is used to search for “relationship information”. This trust level is a scale which represents the degree of trust of a provider, who is described next and has provided the object, with regards to the reception person. However, the trust level may represent the degree of other trust besides this. For example, the trust level may be set based on easiness of falsification of the object, the attribute provided in the object (for example, storage place of the object, possessor). Further, although various scales may be used for the trust level, it is supposed that the trust level according to the present exemplary embodiment uses a value of ten stage evaluation of 1 to 10 and the larger value represents the higher reliability.

“Object supply device” is a device which stores “information related to an object” and provides it. A person who creates, keeps, manages or provides “information related to an object” at the object supply device is called “provider”. Further, as it has already been described, “trust level” of “object” depends on at least “provider” or “object supply device” of the object.

“Address” is information for designating or indicating when accessing to each device, for example, information corresponding to URL (Uniform Resource Locator) of the internet. Although there are various kinds of information which designate the device connected with a network, they are collectively called an address in the description of the present exemplary embodiment.

### First Exemplary Embodiment

First, a first exemplary embodiment according to the present invention will be described with reference to drawings.

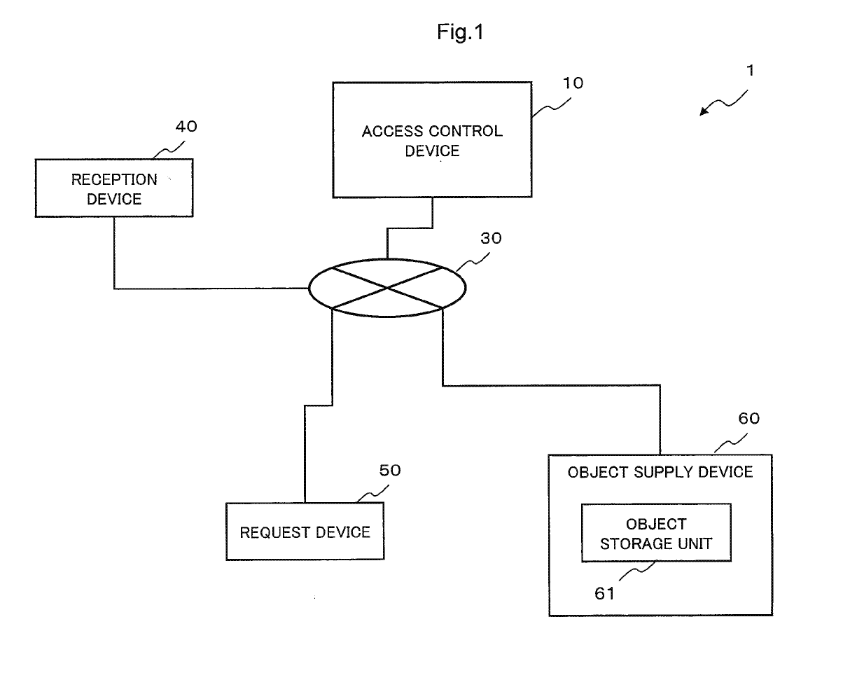

FIG. 1 is a block diagram showing an example of an access control system 1 according to the first exemplary embodiment.

The access control system 1 includes an access control device 10, a network 30, a reception device 40, a request device 50 and an object supply device 60.

Hereinafter, there is also a part which is a repeat, however, each configuration will be described.

The access control device 10, although it will be described in detail later, receives an access request to the reception device 40 from the request device 50 via the network 30, determines a control state of access to the reception device 40 and performs access control.

Further, the control state of access here is the contents of access control of the access control device 10. The access control device 10 according to the present exemplary embodiment can perform access control for various control states of access. For example, the access control device 10 may treat propriety of access to the reception device 40, in other words permission or non-permission of access, as the control state of access. In this case, the access control device 10 performs access control of determination of permission or non-permission of access (permission/non-permission: access propriety) to the reception device 40 as the control state of access. And, the access control device 10 may include the contents of access control as the control state of access. For example, in case of the reception device 40 that can handle mail arrival and call termination as the contents of access control, the access control device 10 selects mail arrival or call termination (the contents of access control). Then, the access control device 10 may treat the permission or non-permission of the selected function as the control state of access, may determine the control state of the access, and may perform the access control. And, the access control device 10 may determine the control state of access in which the selection of the function (for example, mail arrival or call termination) means permission, in other words, “selection” includes “selection” and “determination of access propriety” described above, and perform access control. Further, selection here includes the case of selecting everything.

The network 30 is a communication network which connects each device of the access control system 1. The network 30 may connect so that each device can exchange information, and for example, it may be the internet, also it may be public telephone circuits. Therefore, the detailed description of the network 30 will be omitted. And, because connection establishment and disconnection of the network 30 for each device, or also exchanging data is general protocol processing, the detailed description will be omitted.

The reception device 40 is a target device to which the access control device 10 performs access control based on an access request of the request device 50 which will be mentioned next. The reception device 40 is not limited in particular as long as it is a device, like a computer or a mobile terminal, which can be accessed from other device via the network 30. Therefore, the detailed description of the reception device 40 will be omitted.

The request device 50 requests access to the reception device 40 to the access control device 10. The request device 50 is not limited in particular as long as it is a device, like a computer or a mobile terminal, which can send an access request to the reception device 40 to the access control device 10 via the network 30. Therefore, the detailed description of the request device 50 will be omitted.

The object supply device 60 stores or supplies “information related to an object” which becomes the base of the relationship information which the access control device 10 uses in access control. The object supply device 60 includes an object storage unit 61 which stores “information related to an object”. Further, “information related to an object” stored in the object storage unit 61 is provided by a provider and stored in the object storage unit 61. However, the object supply device 60 may generate “information related to an object” according to the provider's instruction and stores it to the object storage unit 61. The object supply device 60 is not limited in particular as long as it is a device, like a general computer or a server, which can send “information related to an object” to the access control device 10 via the network 30. Therefore, the detailed description of the object supply device 60 will be omitted.

Further, an identifier (ID: identification) of each device according to the present exemplary embodiment and an identifier (ID) of a person who operates a device do not need to be the same. However, in the description of the present exemplary embodiment, unless otherwise noted, for convenience of description, it is supposed that the identifier of each device and the identifier of the person who operates the device are not discriminated, and treated as the same. For example, the ID of the reception device 40 which is operated by the reception person of ID=00001 will be described as 00001.

Further, in the case where an identifier of a device and an identifier of an operating person are separately managed, the access control system 1 can operate similar to the following description by correlating the device to the operating person using a correspondence table of identifiers.

Next, a configuration of the access control device 10 will be described with reference to drawings.

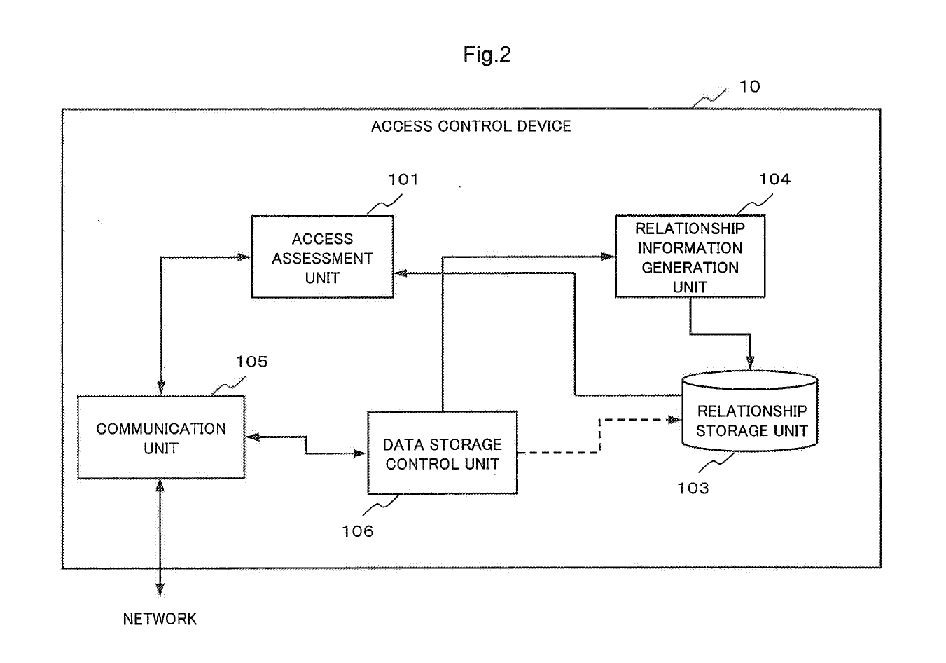

FIG. 2 is a block diagram showing an example of the access control device 10 according to the first exemplary embodiment.

The access control device 10 includes an access assessment unit 101, a relationship storage unit 103, a relationship information generation unit 104, a communication unit 105 and a data storage control unit 106.

The communication unit 105 connects the access control device 10, specifically, the access assessment unit 101 and the data storage control unit 106 to each device via the network 30.

The data storage control unit 106 receives “information related to an object” from the object supply device 60 via the communication unit 105. The data storage control unit 106 extracts, from the received “information related to an object”, “object information” which becomes the base for the relationship information generation unit 104, which will be indicated next, to generate relationship information, and transfers it to the relationship information generation unit 104. Further, the data storage control unit 106 may transfer the object information (, or “information related to an object”) to the relationship storage unit 103, and may store it.

The relationship information generation unit 104 receives the object information from the data storage control unit 106, generates the relationship information which includes relationship of “reception person” and “requester” based on one or a plurality of the object information, transfers it to the relationship storage unit 103, and makes the relationship storage unit 103 store.

The relationship storage unit 103 stores the relationship information received from the relationship information generation unit 104. Further, the relationship storage unit 103 may store the object information (, or “information related to an object”) when there is a request from the data storage control unit 106.

The access assessment unit 101 assesses a control state of access to a reception person (or reception device 40) based on an access request received via the communication unit 105 from a requester (or request device 50). In this assessment, the access assessment unit 101 assesses at least permission or non-permission (permission/non-permission: access propriety) of access to the reception device 40. And, in processing of this assessment, the access assessment unit 101 uses the relationship information in the relationship storage unit 103.

Next, operation of the access control system 1 according to the first exemplary embodiment will be described with reference to FIG. 1 to FIG. 3.

Further, in the description of the present exemplary embodiment, an object of photograph is used as the object. However, this is for convenience of description. The object according to the present exemplary embodiment is not limited to a photograph, but may be other object, for example, such as a brochure, a monograph, or an order slip.

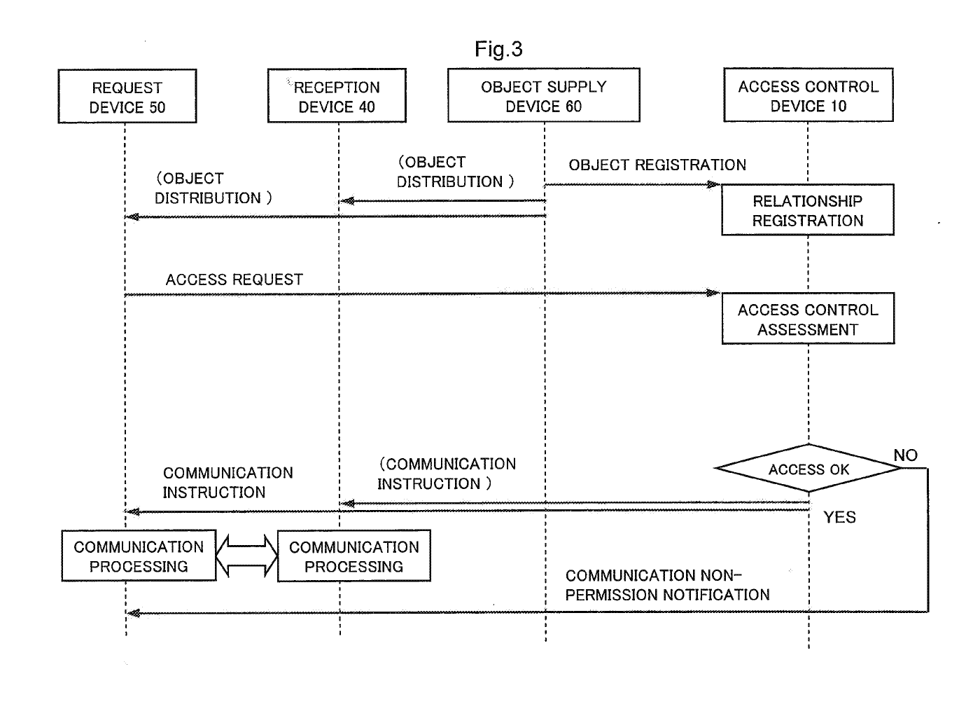

FIG. 3 is a sequence diagram showing an example of operation of the access control system 1.

First, operation of relationship registration which is a preparatory step for the access control system 1 to perform access control will be described.

The object supply device 60 which has received or made “information related to an object” transmits “information related to an object” to the access control device 10. For example, the object supply device 60 may generate, based on operation of a provider, a series of data which includes all data items of the object information 310 which will be described later, and transmit the generated data series to the access control device 10 as “information related to an object”. However, the trust level of the object information 310 is not included in “information related to an object” because the access control device 10 sets it as it will be described later.

The data storage control unit 106 of the access control device 10 which has received “information related to an object” makes the object information 310 based on “information related to an object”, and transfers it to the relationship information generation unit 104. The relationship information generation unit 104 which has received the object information 310 generates the relationship information 320 which will be described later based on the received object information 310, and stores (memorizes) it to the relationship storage unit 103. The relationship storage unit 103 memorizes the relationship information 320. And, as it has been already described, the relationship storage unit 103 may memorize the object information 310.

Further, the object supply device 60 may transmit “information related to an object” to the reception device 40 or the request device 50.

The operation described so far is operation of relationship registration which is a preparatory step of the access control system 1 according to the present exemplary embodiment. Then, the operation described after this will be operation of access control assessment.

The request device 50, when accessing to the reception device 40, transmits an access request for requesting access to the reception device 40 to the access control device 10.

The access control device 10 which has received the access request determines the control state of access, that is, assesses permission, non-permission (permission/non-permission: access propriety) of the access based on the access request and the relationship information 320.

Up to here is operation of access control assessment.

When assessment of access propriety has ended, the access control device 10 transmits the assessment result of access propriety to the request device 50. Further, in a case of access permission (access OK), the access control device 10 may notify (for example, communication instruction) the reception device 40 of access permission. And, the access control device 10 may include information on the contents of access control in this notification of access permission.

When the request device 50 has received the notification (communication instruction) of access permission and an address of the reception device 40 as the notification of assessment result from the access control device 10, the request device 50 accesses the reception device 40 using the received address.

When the request device 50 has received the notification of access non-permission (communication non-permission notification) from the access control device 10, the request device 50 finishes processing of access request.

In this way, operation of the access control system 1 shown in FIG. 3 ends.

Next, individual operation of the access control device 10 will be described.

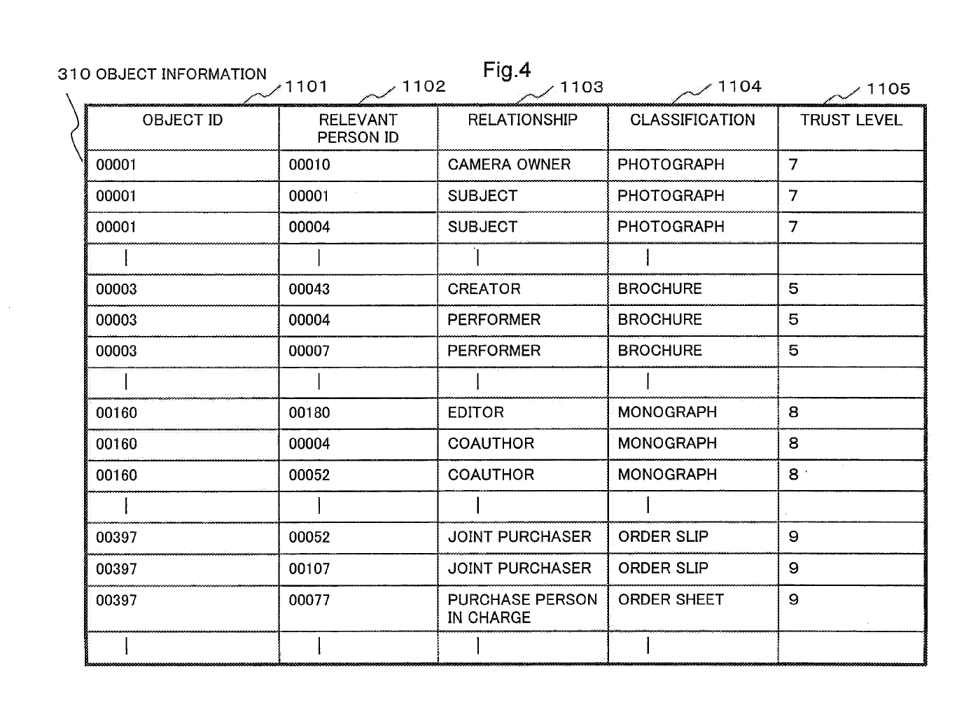

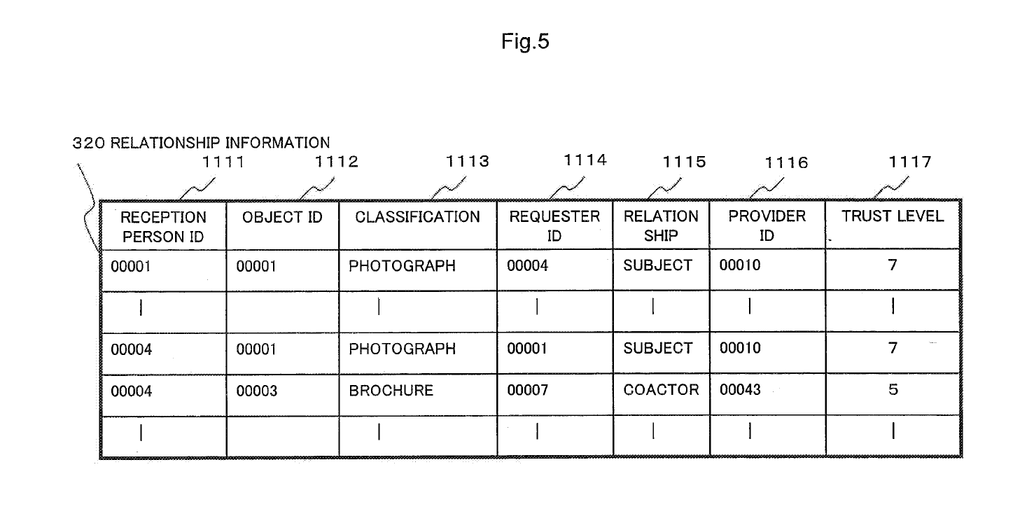

First, the generation operation of the relationship information 320 in the relationship information generation unit 104 will be described with reference to FIG. 4 and FIG. 5.

FIG. 4 is a figure showing an example of the object information 310 which the relationship information generation unit 104 receives. In other words, the object information 310 shown in FIG. 4 is an example of the object information 310 which the data storage control unit 106 has extracted from “information related to an object”. Further, the relationship information generation unit 104 may receive the object information 310 one by one, or may receive plural in a lump. For convenience of description, FIG. 4 indicates a plurality of the object information 310.

The object information 310 shown in FIG. 4 includes object ID 1101, relevant person ID 1102, relationship 1103, classification 1104 and trust level 1105.

The object ID 1101 is an identifier for identifying an object uniquely. In other words, an object is identified based on the object ID.

The relevant person ID 1102 is an identifier which indicates a relevant person included in the object. This relevant person ID becomes an identifier of various users (for example, a reception person, a requester) of the relationship information 320 which will be described later.

The relationship 1103 of the object information 310 indicates relationship of the object with the relevant person included in its object. For example, “subject” indicates relationship with a person who was photographed in the photograph which is its object. Accordingly, the relevant person who is the subject of (the object of) a certain photograph becomes the person who was photographed in the photograph together. And, “owner of camera” indicates an owner of camera who took the photograph (object). Because generally the owner of camera provides photographs, in the present exemplary embodiment, the owner of camera who took the photograph is regarded as a provider who has provided the photograph.

The classification 1104 is classification of the object. For example, the photograph shown in FIG. 4 indicates a general photograph, and the brochure (a pamphlet, a booklet) indicates a brochure of a concert or a drama. Further, the classification 1104 is not limited to the classification shown in FIG. 4, but may also be other classification.

The trust level 1105 is a trust level of the object. This trust level 1105 is a scale of the trust which a reception person sets to the object information 310 based on a provider (or object supply device 60). The data storage control unit 106 sets the trust level 1105 to the object information 310. The trust level 1105 that the reception person according to the present exemplary embodiment sets is not limited in particular. The data storage control unit 106 can set the trust level 1105 by various methods. For example, the access control device 10 stores a value, which is set to the trust level for each provider (or object supply device 60) of the object, in a storage unit which is not illustrated in advance. The data storage control unit 106, when extracting the object information 310, may set the trust level 1105 of the object information 310 based on the value that is set to the received provider (or object supply device 60) stored in the above-mentioned storage unit. When this operation is described specifically, for example, it is as follows. The reception device 40 transmits the value that is set to the trust level for each camera owner who took (the object of) the photograph to the access control device 10 in advance. The access control device 10 stores its value. The data storage control unit 106 which has received “information related to an object” of the photograph confirms the owner of camera who took the received (object of) photograph based on “information related to an object” when extracting the object information 310 of the photograph. Then, the data storage control unit 106 sets the trust level 1105 of the object information 310 based on the owner of camera and the previously stored value that is to be set to the trust level. Further, attribute of the object, which is used when the access control device 10 sets to the trust level, is not limited to the provider, but may also be based on other attribute.

When the object information 310 is described using the data shown in FIG. 4, it is as follows.

The first line of the object information 310 of FIG. 4 is the object in which the object ID 1101 is 00001, and the classification 1104 is a photograph. The object of this photograph is the photograph which the camera owner of the relevant person ID 1102=00010 has taken. Further, the second line and the third line of the object information 310 having the same object ID indicate that two relevant persons of the relevant person ID=00001 and the relevant person ID=00004 respectively are photographed as the subject of the object of this photograph. In other words, the relevant person ID=00001 and the relevant person ID=00004 are photographed in this photograph simultaneously.

The relationship information generation unit 104 receives the object information 310 described above and generates the relationship information 320.

For example, when describing a case where the object information 310 received from the data storage control unit 106 is the object of the object ID=00001 shown in FIG. 4 (from the first line to the third line of FIG. 4), it is as follows. The relationship information generation unit 104 judges, from the object information 310, that it is the object of the photograph in which two people of ID=00001 and ID=00004 are the subjects, and extracts those ID, the relationship (subject) and the classification (photograph). Further, the relationship information generation unit 104 also extracts the ID (00010) of the person (camera owner) who provided the object and the trust level=7 from the object information 310. Next, the relationship information generation unit 104 makes the relationship information 320 based on these extracted information, transfers it to the relationship storage unit 103, and stores it to the relationship storage unit 103.

Further, in this case, the relationship information generation unit 104 makes two of the relationship information 320. This reason is because, as there are two persons as the subjects in the photograph of the target object, the relationship information generation unit 104 generates the relationship information 320 corresponding to the respective subjects.

FIG. 5 is a figure showing an example of the relationship information 320 which the relationship information generation unit 104 generates.

The relationship information 320 shown in FIG. 5 includes reception person ID 1111, object ID 1112, classification 1113, requester ID 1114, relationship 1115, provider ID 1116 and trust level 1117.

The relationship information 320 shown in FIG. 5 is information in which the reception person ID 1111 is correlated to each data of the object ID 1112, the classification 1113, the requester ID 1114, the relationship 1115, the provider ID 1116 and the trust level 1117. The relationship information 320 is stored in the relationship storage unit 103 by a list form. Further, a storage method of the relationship information 320 according to the present exemplary embodiment is not limited to this, but it may store by a general data storage method, for example, a relational database.

The reception person ID 1111 indicates an identifier (ID) of a reception person, and is used for assessment of reception person in the access assessment unit 101. This reception person ID 1111 is the ID selected from the relevant person ID 1102 of the object information 310.

The object ID 1112 is an identifier (ID) for identifying an object of the relationship information 320. The object ID 1112 corresponds to the object ID 1101 of the object information 310 shown in FIG. 4.

The classification 1113 is classification of the object of the relationship information 320. The classification 1113 corresponds to the classification 1104 shown in FIG. 4.

The requester ID 1114 is a relevant person who is included in the object information 310 of the object ID 1112, in other words, a relevant person who has relationship with the reception person ID 1111 about the object ID 1112. The requester ID 1114 is the relevant person ID 1102 of any of the persons excepted for a person who has been selected as the reception person ID from the relevant person ID 1102 included in the object information 310 shown in FIG. 4.

The relationship 1115 of the relationship information 320 indicates relationship of the reception person indicated by the reception person ID 1111 and the requester indicated by the requester ID 1114. For example, “subject” in the relationship 1115 indicates that the reception person and the requester were photographed in one photograph, and “coactor” indicates that the reception person and the requester acted in one play or concert. The relationship is not limited to the relationship 1115 shown in FIG. 5, but may also be other relationship. The relationship 1115 corresponds to the relationship 1103 of the object information 310 shown in FIG. 4.

The provider ID 1116 is an identifier (ID) which indicates a provider of the object information 310. The provider ID 1116 is extracted based on the relevant person ID 1102 and the relationship 1103 of the object information 310 shown in FIG. 4. For example, if the object is a photograph, the provider ID is the ID of camera owner or photographer who photographed the object. Further, although not shown in FIG. 5, the provider of object is not limited to one person, but may also be plural.

The trust level 1117 is a trust level of the object indicated by the object ID 1112. The trust level 1117 corresponds to the trust level 1105 shown in FIG. 4.

Further, when the relationship information 320 is described using the specific data of FIG. 5, it is as follows.

The first line of the relationship information 320 of FIG. 5 indicates that the reception person (ID=00001) was photographed with the requester having the identifier of ID=00004 as the subject of the photograph (object ID=00001). Further, this relationship information 320 also indicates that (the object of) this photograph is the photograph received from the provider having provider ID=00010, and the trust level is 7. In this way, information on the first line of the relationship information 320 is the information which includes the reception person (ID=00001) and the requester (ID=00004) in one information.

Further, for efficiency of processing, the relationship information 320 according to the present exemplary embodiment may be processed or stored, by simplifying the relationship of “reception person” and “requester”, as information on “reception device 40” and “request device 50”.

The relationship information generation unit 104 according to the present exemplary embodiment may generate the relationship information 320 based on one object information 310, or may generate the relationship information 320 based on a plurality of object information 310.

The relationship information generation unit 104 in relationship registration shown in FIG. 3 operates in this way and generates the relationship information 320.

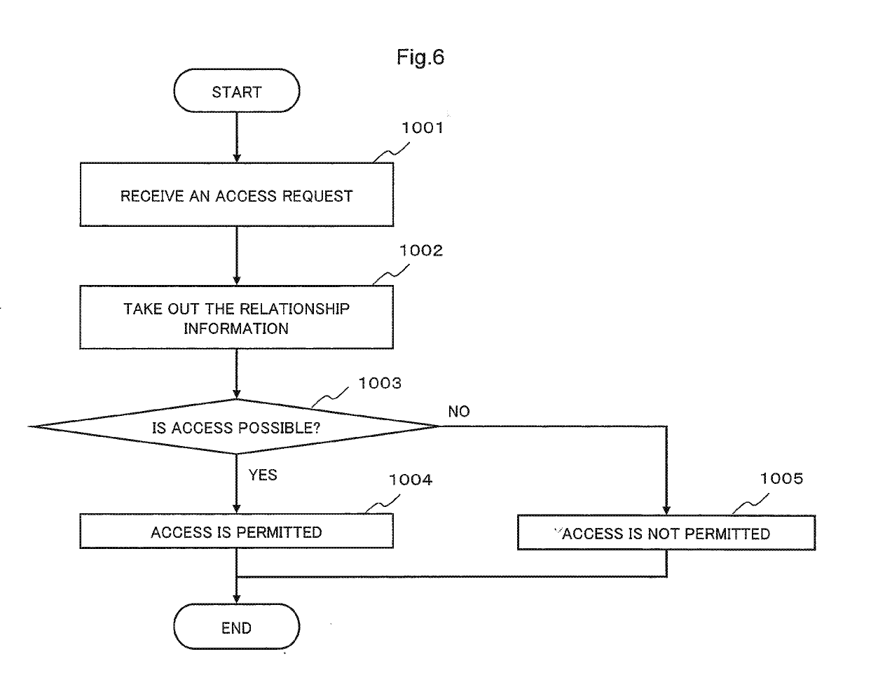

Next, operation of the access control device 10 in access control assessment shown in FIG. 3 will be described with reference to FIG. 2, FIG. 5 and FIG. 6. Further, the description here will describe the operation until notification by the access control device 10 shown in FIG. 3.

FIG. 6 is a flowchart showing an example of operation of access control assessment by the access control device 10 according to the first exemplary embodiment.

The access assessment unit 101 receives an access request via the communication unit 105 (Step 1001). This access request includes a reception person ID who operates the reception device 40 which is a target of the access request and a requester ID who operates the request device 50 in addition to the information which indicates the access request.

The access assessment unit 101 which has received the access request assesses whether or not there is the relationship information 320 which includes the reception person ID and the requester ID (Step 1002).

When there is the relationship information 320 (in Step 1003, yes), the access assessment unit 101 permits access. In this case, the access assessment unit 101 notifies the request device 50 of permission of access and an address for accessing the reception device 40 via the communication unit 105 (Step 1004).

When there is no relationship information 320 (in Step 1003, no), the access assessment unit 101 disapproves of access. In this case, the access assessment unit 101 notifies the request device 50 of access non-permission (communication non-permission notification) via the communication unit 105 (Step 1005).

Operating in this way, the access control system 1 controls access propriety based on the relationship information 320.

Further, operation of assessment of the access request which the access assessment unit 101 of the access control device 10 has received will be described with reference to the relationship information 320 shown in FIG. 5.

The access assessment unit 101 does not need to use all items of the relationship information 320 shown in FIG. 5. Therefore, several examples in which the used items are different will be described.

The access assessment unit 101 assesses an access request from a requester to a reception person. Accordingly, the access assessment unit 101 assesses the access propriety using at least the reception person ID 1111 and the requester ID 1114 of the relationship information 320.

Therefore, first, a case where the access assessment unit 101 uses the reception person ID 1111 and the requester ID 1114 of the relationship information 320 will be described.

The access assessment unit 101 assesses whether or not there is the relationship information 320 which includes the reception person ID 1111 and the requester ID 1114 included in the access request. When there is the relationship information 320 which includes the reception person ID 1111 and the requester ID 1114 by one, the access assessment unit 101 assesses as access permission. When there is no relationship information 320 which includes the reception person ID 1111 and the requester ID 1114 by one, the access assessment unit 101 assesses as access non-permission.

Next, a case where other items of the relationship information 320 are also used will be described. The description of each item is the description of operation when each item is added to the reception person ID 1111 and the requester ID 1114. Hereinafter, although it will describe the case of three items which are the reception person ID 1111, the requester ID 1114 and each item, for convenience of description, the access assessment unit 101 according to the present exemplary embodiment is not limited to this, but may assess by beyond four items.

First, a case where the relationship 1115 is used will be described.

The access control device 10 holds permitted relationship or stores in a memory storage which is not illustrated in advance.

Then, when the access assessment unit 101 of the access control device 10 receives an access request, it assesses whether or not there is the relationship information 320 which includes the reception person ID 1111 and the requester ID 1114 included in the received access request. When there is the relationship information 320 which includes the reception person ID 1111 and the requester ID 1114 by one, the access assessment unit 101 assesses the relationship 1115 of the relationship information 320. When the relationship 1115 is same as the relationship which the reception person permits and held in advance, the access assessment unit 101 assesses as access permission. When there is no relationship information 320 which includes the reception person ID 1111 and the requester ID 1114 by one, or it is different in the relationship 1115, the access assessment unit 101 assesses as access non-permission.

It will describe specifically using the relationship information 320 on the first line of FIG. 5. The data of the first line of FIG. 5 is reception person ID 1111=00001, requester ID 1114=00004 and relationship 1115=subject. In other words, the data of the first line of FIG. 5 indicates that the reception person of ID=00001 is the subject of the same photograph as the requester of ID=00004. Therefore, when the reception person of ID=00001 permits the subject as the relationship with the requester of ID=00004, the access assessment unit 101 assesses as permission. Alternatively, when the reception person of ID=00001 permits all except for the subject as the relationship with the requester of ID=00004, the access assessment unit 101 assesses as non-permission.

Next, a case where the trust level 1117 is used will be described.

The access control device 10 holds a permitted trust level or stores in a memory storage which is not illustrated in advance.

Then, when the access assessment unit 101 receives an access request, it assesses whether or not there is the relationship information 320 which includes the reception person ID 1111 and the requester ID 1114 included in the received access request. When there is the relationship information 320 which includes the reception person ID 1111 and the requester ID 1114 by one, the access assessment unit 101 assesses the trust level 1117 of the relationship information 320. When the trust level 1117 is same as the trust level held in advance or high, the access assessment unit 101 assesses as access permission. When there is no relationship information 320 which includes the reception person ID 1111 and the requester ID 1114 by one, or the trust level 1117 is lower than the assessed trust level, the access assessment unit 101 assesses as access non-permission.

It will describe specifically using the relationship information 320 on the first line of FIG. 5. The data of the first line of FIG. 5 is reception person ID 1111=00001, requester ID 1114=00004 and trust level 1117=7. In other words, the data of the first line of FIG. 5 indicates that the trust level of the reception person of ID=00001 and the requester of ID=00004 is 7. Therefore, when the reception person of ID=00001 sets the trust level of no more than 7 as the trust level with the requester of ID=00004, the access assessment unit 101 assesses as permission. Alternatively, when the reception person of ID=00001 sets no smaller than 8 as the trust level with the requester of ID=00004, the access assessment unit 101 assesses as non-permission.

Next, a case where the provider ID 1116 is used will be described.

The access control device 10 holds a permitted provider of object or stores in a memory storage which is not illustrated in advance.

Then, when the access assessment unit 101 receives an access request, it assesses whether or not there is the relationship information 320 which includes the reception person ID 1111 and the requester ID 1114 included in the access request. When there is the relationship information 320 which includes the reception person ID 1111 and the requester ID 1114 by one, the access assessment unit 101 assesses the provider ID 1116 of the relationship information 320. When the provider ID 1116 is same as the provider held in advance, the access assessment unit 101 assesses as access permission. When there is no relationship information 320 which includes the reception person ID 1111 and the requester ID 1114 by one, or it is different in the provider ID 1116, the access assessment unit 101 assesses as access non-permission.

It will describe specifically using the relationship information 320 on the first line of FIG. 5. The data of the first line of FIG. 5 is reception person ID 1111=00001, requester ID 1114=00004 and provider ID 1116=0010. In other words, the data of the first line of FIG. 5 indicates that the ID of provider of the object including the reception person of ID=00001 and the requester of ID=00004 is 00010. Therefore, when the reception person of ID=00001 sets 00010 as the provider ID of the object including the requester of ID=00004, the access assessment unit 101 assesses as permission. Alternatively, when the reception person of ID=00001 sets all except for ID=00010 as the provider, the access assessment unit 101 assesses as non-permission.

Next, a case where the classification 1113 is used will be described.

The access control device 10 holds permitted classification of object or stores in a memory storage which is not illustrated in advance.

Then, when the access assessment unit 101 receives an access request, it assesses whether or not there is the relationship information 320 which includes the reception person ID 1111 and the requester ID 1114 included in the received access request. When there is the relationship information 320 which includes the reception person ID 1111 and the requester ID 1114 by one, the access assessment unit 101 assesses the classification 1113 of the relationship information 320. When the classification 1113 is same as the classification held in advance, the access assessment unit 101 assesses as access permission. When there is no relationship information 320 which includes the reception person ID 1111 and the requester ID 1114 by one, or it is different in the classification 1113, the access assessment unit 101 assesses as access non-permission.

It will describe specifically using the relationship information 320 on the first line of FIG. 5. The data of the first line of FIG. 5 is reception person ID 1111=00001, requester ID 1114=00004 and classification 1113=photograph. In other words, the data of the first line of FIG. 5 indicates that the classification of the object including the reception person of ID=00001 and the requester of ID=00004 is a photograph. Therefore, when the reception person of ID=00001 sets a photograph as the classification of the object including the requester of ID=00004, the access assessment unit 101 assesses as permission. Alternatively, when the reception person of ID=00001 sets all except for a photograph as classification of the object including the requester of ID=00004, the access assessment unit 101 assesses as non-permission.

It is similar when the object ID 1112 is used.

The access control device 10 holds a permitted object ID or stores in a memory storage which is not illustrated in advance.

Then, when the access assessment unit 101 receives an access request, it assesses whether or not there is the relationship information 320 which includes the reception person ID 1111 and the requester ID 1114 included in the received access request. When there is the relationship information 320 which includes the reception person ID 1111 and the requester ID 1114 by one, the access assessment unit 101 assesses the object ID 1112 of the relationship information 320. When the object ID 1112 is same as the object ID held in advance, the access assessment unit 101 assesses as access permission. When there is no relationship information 320 which includes the reception person ID 1111 and the requester ID 1114 by one, or it is different in the object ID 1112, the access assessment unit 101 assesses as access non-permission.

It will describe specifically using the relationship information 320 on the first line of FIG. 5. The data of the first line of FIG. 5 is reception person ID 1111=00001, requester ID 1114=00004 and object ID 1112=00001. In other words, the data of the first line of FIG. 5 indicates that the object ID including the reception person of reception person ID 1111=00001 and the requester of requester ID 1114=00004 is 00001. Therefore, when the reception person of ID=00001 sets 00001 as the object ID including ID=00004, the access assessment unit 101 assesses as permission. Alternatively, when the reception person of ID=00001 sets all except for 00001 as the object ID including the requester of ID=00004, the access assessment unit 101 assesses as non-permission.

Further, the access control system 1 according to the present exemplary embodiment is not limited to a configuration having been described up to here.

The access control system 1 may be one device by a plurality of composition. For example, the access control system 1 may compose one device by the access control device 10 and the reception device 40. In other words, the reception device 40 may operate with including the access control device 10.

Moreover, a part or whole of each device of the access control system 1 or each composition of the access control device 10 may be a program which a computer executes.

Alternatively, each device of the access control system 1 or each composition of the access control device 10 may include a storing medium which stores a program which a computer executes. For example, the program which controls the access control device 10 may be included in the data storage control unit 106.

And, the access control system 1 may configure each device as a plurality of devices. For example, the access control device 10 is not only limited to the configuration shown in FIG. 2, but also may make the relationship information generation unit 104 a different device. Moreover, the access control device 10 may be a device which is included in a part of another device, for example, a server which manages the network.

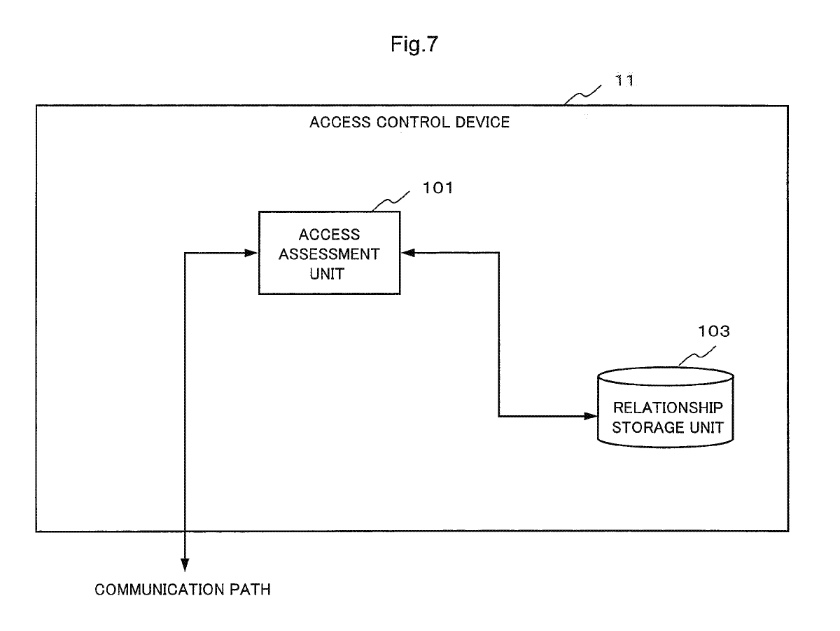

FIG. 7 is a block diagram showing a different configuration of the access control device.

In FIG. 7, the same number is assigned to the same configuration as FIG. 2.

For example, an access control device 11 connects with other device via a bus like a blade server. Therefore, the communication unit 105 is omitted in FIG. 7. Further, the relationship information generation unit 104 and the data storage control unit 106 are provided in the other device which is not illustrated, and the access control device 11 connects with the other device via the bus. And, the relationship storage unit 103 of the access control device 11 stores the relationship information 320 for which the relationship information generation unit 104 which is not illustrated has searched. Therefore, illustration of the relationship information generation unit 104 and the data storage control unit 106 is also omitted.

The access control device 11 which is configured in this way can also perform access control based on the relationship information 320 similar to the access control device 10.

The access control device 11 shown in this FIG. 7 is the minimum configuration according to the present exemplary embodiment.

Further, the request device 50 sends an access request to the access control device 10 in the access control system 1 according to the present exemplary embodiment described up to here. However, the access control system 1 according to the present exemplary embodiment is not limited to this. In the access control system 1 according to the present exemplary embodiment, the request device 50 may send the access request to the reception device 40, and the reception device 40 may request assessment of the control state of access to the access control device 10. Such access control system 1 can also assess the control state of access even if a reception person does not operate the reception device 40.

Thus, the access control system 1, the access control device 10 and the access control device 11 (hereinafter, referred to as an access control device 10 or the like) according to the first exemplary embodiment can obtain the effect that reduces a burden on a reception person and controls access.

The reason is because the access control device 10 or the like controls access based on the relationship information 320 which includes relationship with the requester who has performed an access request and the reception person who is an owner of the device of access target even if the reception person does not control the access.

### Second Exemplary Embodiment

In a photograph, it may happen that a third person without relationship is taken simultaneously. Further, it is possible for a third person to fabricate digital photograph and material. Therefore, like the access control device 10 according to the first exemplary embodiment, when the access control is performed only by the relationship information 320 based on the object information 310, there is a possibility of problem in reliability of the object information 310, which is the base of judgment of control contents, and safety of the access control as a result of the judgment.

An access control device 12 according to a second exemplary embodiment performs access control which secures the reliability and safety using a policy of reception person.

First, a configuration of the second exemplary embodiment according to the present invention will be described with reference to drawings.

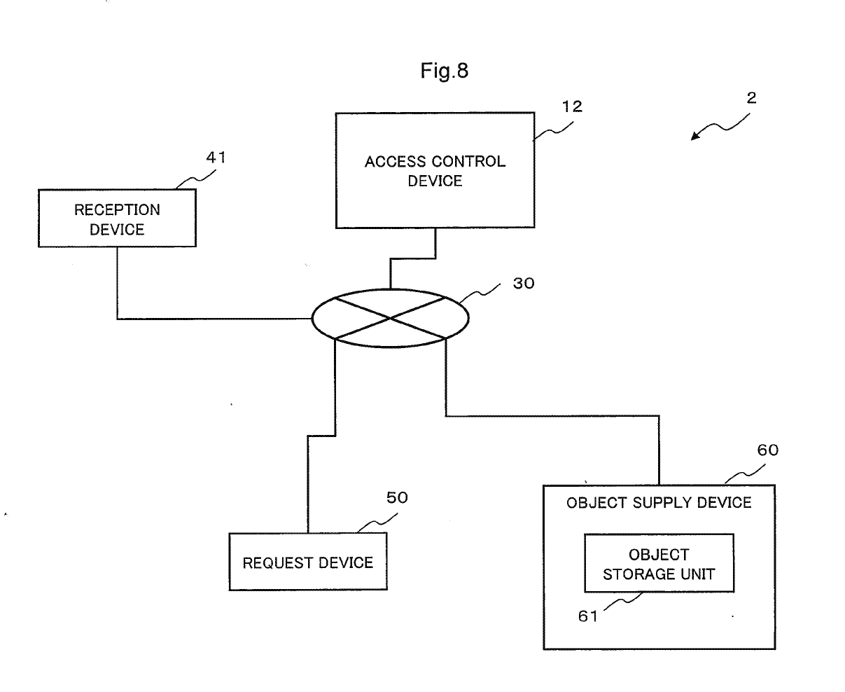

FIG. 8 is a block diagram showing an example of the configuration of an access control system 2 according to the second exemplary embodiment.

The access control system 2 includes an access control device 12, the network 30, a reception device 41, the request device 50 and the object supply device 60. In FIG. 8, the same number is assigned to the same configuration as FIG. 1, and the detailed description will be omitted.

The access control device 12 handles a policy of reception person which will be described in detail later in addition to the same configuration and operation as the access control device 10 according to the first exemplary embodiment.

The reception device 41 is a target device which the access control device 12 accesses based on an access request of the request device 50. The reception device 41 transmits a policy of reception person to the access control device 12 in addition to the same configuration and operation as the reception device 40 according to the first exemplary embodiment. As the operation of sending a policy by the reception device 41 is the same as the transmission operation of general data, the detailed description will be omitted.

Next, a configuration of the access control device 12 will be described with reference to a drawing.

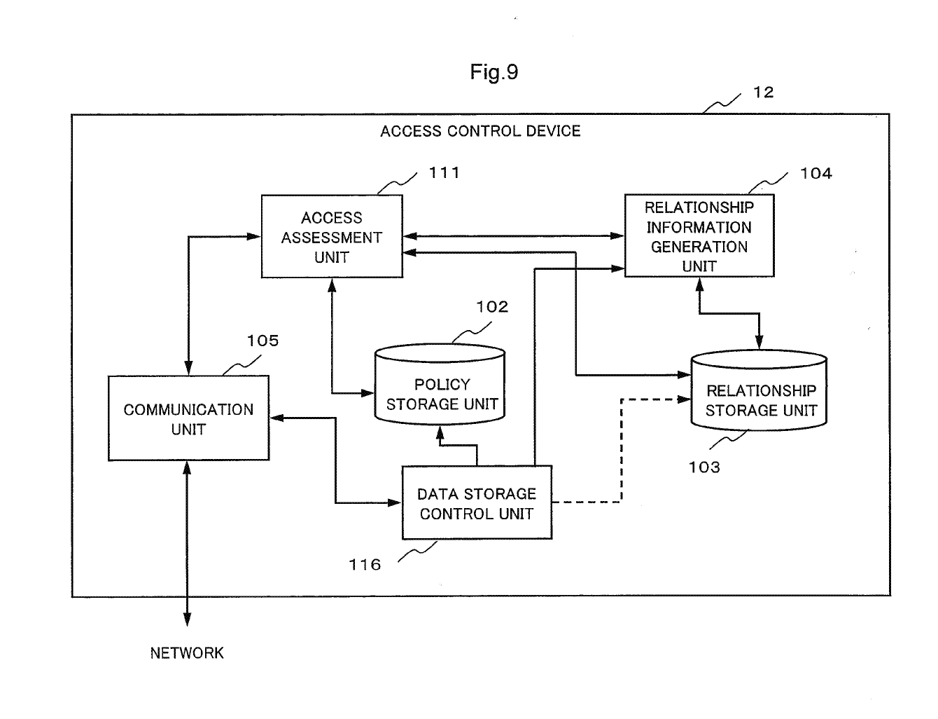

FIG. 9 is a block diagram showing an example of the access control device 12 according to the second exemplary embodiment. In FIG. 9, the same number is assigned to the same configuration as FIG. 2, and the detailed description will be omitted.

An access assessment unit 111 uses information of a policy storage unit 102 for assessment in addition to the same operation as the access assessment unit 101 according to the first exemplary embodiment.

A data storage control unit 116 stores a policy of reception person which has received via the communication unit 105 to the policy storage unit 102 in addition to the same operation as the data storage control unit 106 according to the first exemplary embodiment.

The policy storage unit 102 stores a policy of access control (also referred to as an access policy) to the reception device 41 which a reception person has created. Further, the reception person, before the access control, sets this policy to the access control device 10 in advance using the reception device 41 or a device which is not illustrated. Because this setting processing may be similar to the transmission processing of general data, the detailed description about the setting operation of policy will be omitted. Further, it is for unification of receiving window of the stored data that the policy storage unit 102 according to the present exemplary embodiment receives a policy via the data storage control unit 116. However, the present exemplary embodiment is not limited to this. For example, the policy storage unit 102 may receive a policy via the communication unit 105.

Next, the data of policy stored in the policy storage unit 102 will be described.

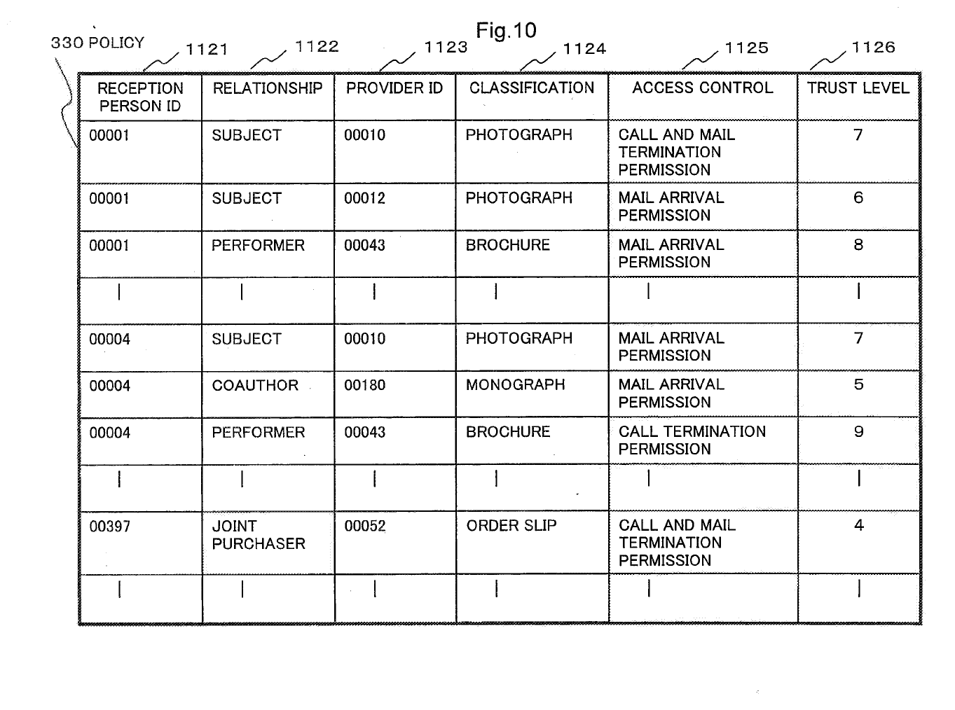

FIG. 10 is a figure showing an example of the policy 330 which the policy storage unit 102 according to the present exemplary embodiment stores.

The policy 330 shown in FIG. 10 includes reception person ID 1121, relationship 1122, provider ID 1123, classification 1124, access control 1125 and trust level 1126. The policy 330 is an example of information in the case where it is stored by a list form in which the reception person ID 1121 is correlated to each data of the relationship 1122, the provider ID 1123, the classification 1124, the access control 1125 and the trust level 1126. Further, a storage method of the policy 330 according to the present exemplary embodiment is not limited to this, but may also be stored by a form for storing general data, for example, a form of the relational database.

Next, each data item of the policy 330 shown in FIG. 10 will be described.

The reception person ID 1121 is an identifier (ID) for identifying a reception person uniquely. The access assessment unit 111, using identification of this reception person ID, assesses which reception person's policy 330 it is. The access assessment unit 111, using this reception person ID, performs access control based on the different policy 330 for each reception person. The reception person ID 1121 corresponds to the reception person ID 1111 of the relationship information 320 shown in FIG. 5.

The relationship 1122 is the characteristic that indicates a relation between a reception person and a requester. The relationship 1122 corresponds to the relationship 1115 of the relationship information 320 shown in FIG. 5.

The provider ID 1123 is an identifier (ID) for identifying a person who has provided the object information 310. The provider ID 1123 corresponds to the provider ID 1116 of the relationship information 320 shown in FIG. 5.

The classification 1124 indicates the type (classification) of the object used for assessment of access control. The classification 1124 corresponds to the classification 1113 of the relationship information 320 shown in FIG. 5.

The access control 1125 indicates the contents of access control which the access control device 12 permits. For example, “call and mail termination permission” indicates permission of termination for a call and a mail. And, “mail arrival permission” indicates permission of mail arrival. Further, the contents of access control is not limited to an example shown in FIG. 10, but may also be other access control.

The trust level 1126 is an item that indicates the degree of trust of the object and corresponds to the trust level 1117 of the relationship information 320 shown in FIG. 5. As it has been already described, the trust level of the present exemplary embodiment is expressed by a value of ten stages, and the larger value represents the higher reliability. Then, the trust level 1126 of the policy 330 according to the second exemplary embodiment indicates the minimum of the trust level. For example, trust level=7 of the policy 330 in the first line indicates that it permits when the trust level is no smaller than 7, in other words, the value of the trust level 1117 of the relationship information 320 is no smaller than 7.

When the policy 330 is described using the specific value in FIG. 10, it is as follows.

The first line of the policy 330 of FIG. 10 is the policy 330 about the reception person whose reception person ID 1121 is “00001”. Further, the first line of the policy 330 is the policy 330 to be applied to the requester whose relationship 1122 is a subject in the classification 1124 which is provided by the provider whose provider ID 1123 is 00010 and who is a subject and which is a photograph. Further, the access control is call and mail termination permission when the first line of this policy 330 is applied. And, the first line of this policy 330 permits the access control when the requester is photographed together with the reception person as a subject of the photograph whose trust level is no smaller than 7.

Further, the access control device 12 according to the present exemplary embodiment may use all data items of the policy 330 shown in FIG. 10 for access control, or may also use a part of the data items.

Next, operation of the access control system 2 according to the second exemplary embodiment will be described with reference to FIG. 9 to FIG. 11.

Further, in the description of the present exemplary embodiment, the object of photograph is used as the object, however, this is for convenience of description. The object according to the present exemplary embodiment is not limited to a photograph, but may be other objects, for example, such as a brochure, a monograph, or an order slip as shown in FIG. 4.

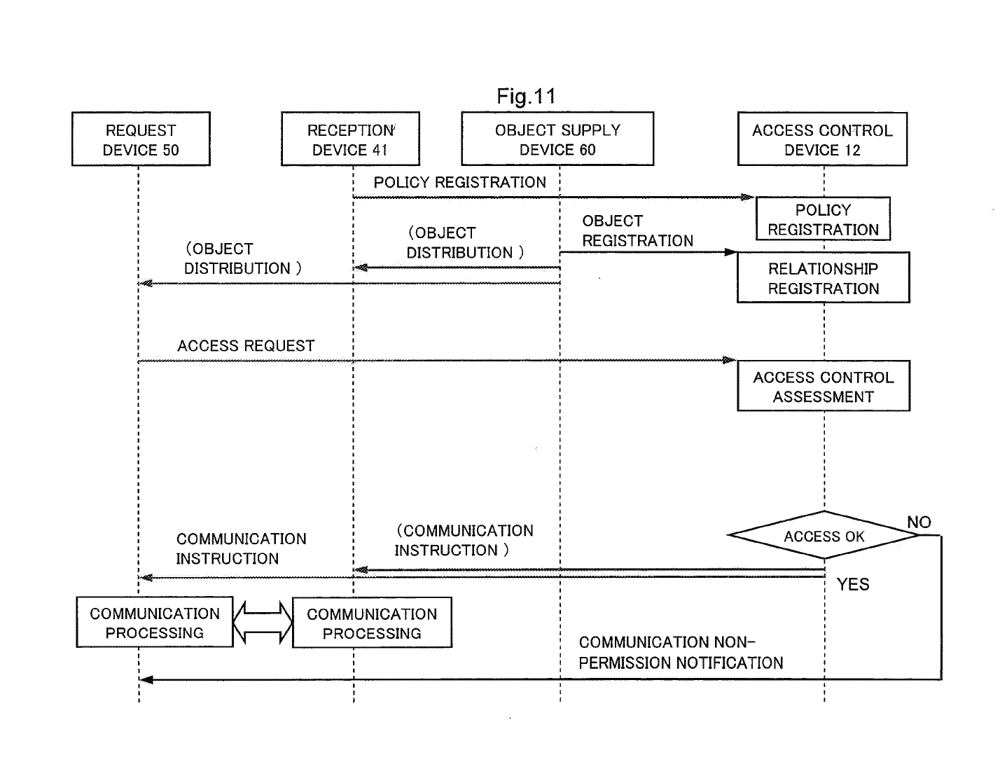

FIG. 11 is a sequence diagram showing an example of operation of the access control system 2. First, operation of a preparatory step which includes registration of the policy 330, delivery of “information related to an object” and registration of the relationship information 320 will be described.

The reception device 41 transmits the policy 330 which the reception person has designated to the access control device 12. For example, the reception device 41, based on operation by a reception person, may generate a series of data which includes all data items of the policy 330 of FIG. 10, and may transmit the generated data series to the access control device 12 as the policy 330. The access control device 12 which has received the policy 330 stores (preserves) the policy 330 to the policy storage unit 102.

And, the access control device 12 receives “information related to an object” from the object supply device 60, makes the relationship information 320 and stores. As this processing is same as the access control device 10 of the first exemplary embodiment, the detailed description will be omitted.

The operation described up to here is operation of a preparatory step of the access control system 2 according to the present exemplary embodiment. Then, the operation described after this will be operation of access permission assessment.

First, the request device 50, when accessing the reception device 41, transmits an access request for requesting access to the reception device 41 to the access control device 12.

The access control device 12 which has received the access request determines the control state of access, that is, assesses permission, non-permission of access (permission/non-permission: access propriety) based on the policy 330 and the relationship information 320. When the assessment of access permission ends, the access control device 12 transmits the assessment result of permission/non-permission of the access to the request device 50. Further, when access is permission (access OK), the access control device 12 may also notify the reception device 41 of access permission (for example, communication instruction). The access control device 12 may include information on the contents of access control in the notification of access permission (notification instruction).

When the request device 50 has received the notification of access permission (communication instruction) and an address of the reception device 41 from the access control device 12, the request device 50 accesses the reception device 41 using the information on the contents of access control and the received address.

When the request device 50 has received the notice of access non-permission (communication non-permission notification) from the access control device 12, the request device 50 ends processing of the access request. Further, the request device 50 may perform retry of the access request.

In this way, the access control system 2 operates similar to the access control system 1 except for operation of access permission assessment of the access control device 12.

Operation of the access control device 12 will be further described with reference to drawings.

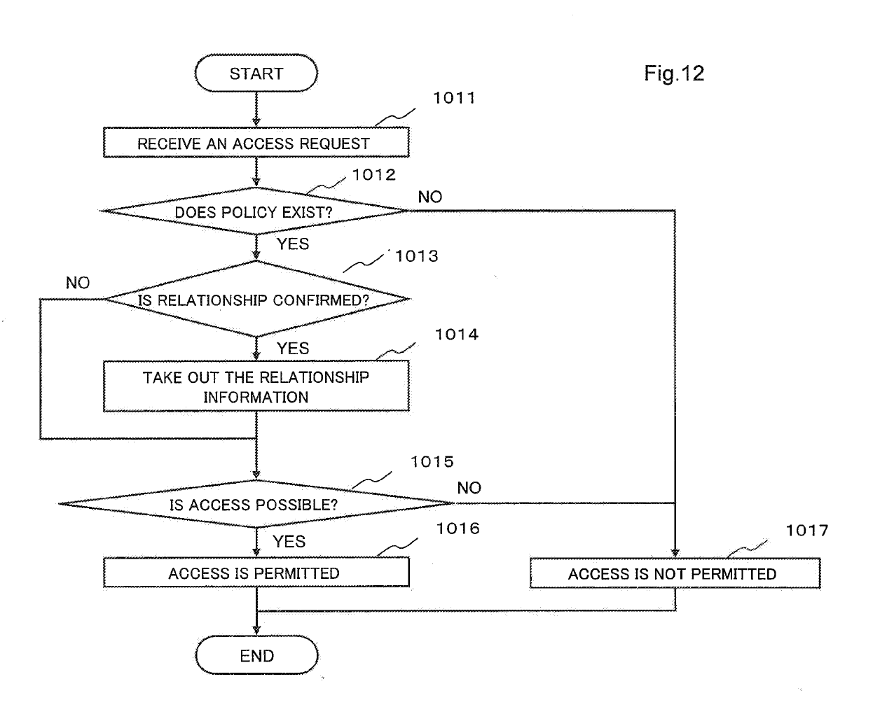

Operation of the access control device 12 will be described with reference to FIG. 5, FIG. 10 and FIG. 12.

FIG. 12 is a flowchart showing an example of operation of access control of the access control device 12.

The access assessment unit 111 receives an access request via the communication unit 105 (Step 1011). The access request includes the reception person ID which is subject to the access request and the requester ID in addition to the access request information.

The access assessment unit 111 which has received the access request searches for the policy 330 which the policy storage unit 102 stores based on the reception person ID 1121 and the requester ID of the received access request, and assesses whether or not there is the policy 330 which includes the reception person ID 1121 and the requester ID (Step 1012).

When there is the policy 330 which includes the reception person ID 1121 (in Step 1012, yes), the access assessment unit 111 assesses whether or not the policy 330 uses the relationship information 320 (Step 1013). This is because the policy 330 according to the present exemplary embodiment may include the policy 330 which does not consider the relationship information 320.

When the policy 330 considers the relationship information 320 (in Step 1013, yes), the access assessment unit 111 searches for the required relationship information 320 from the relationship storage unit 103 based on the information on the reception person ID 1121 in the policy 330 (Step 1014).

The access assessment unit 111 which has received the relationship information 320 assesses the control state of access based on the policy 330 and the relationship information 320 (Step 1015).

When a result of the assessment is access permission (in Step 1005, yes), the access assessment unit 111 transmits notification of access permission and an address of the reception device 41 to the request device 50 via the communication unit 105 (Step 1016). On this occasion, the access assessment unit 111 may notify the reception device 41 of access permission. The access assessment unit 111 may include the contents of access control such as, for example, information on mail arrival permission, call termination permission or the like in the notification of access permission.

When an assessment result is access non-permission (in Step 1015, no), the access assessment unit 111 notifies the request device 50 of access non-permission via the communication unit 105 (Step 1017).

When the relationship information 320 is not considered (in Step 1013, no), the access assessment unit 111 assesses permission, non-permission (permission/non-permission: access propriety) of access based on the policy 330 (Step 1015). As the operation of Step 1015 which does not consider the relationship information 320 is same as the operation of access control based on a general policy 330, the detailed description will be omitted.

When the reception person ID is not included in the policy 330 (in Step 1012, no), the reception person (and reception device 41) indicated by its reception person ID does not have setting of the access control. Therefore, the access assessment unit 111 notifies the request device 50 of access non-permission via the communication unit 105 (Step 1017).

Further, the operation in a case where the reception person ID is not included in the policy 330 is not limited to this. The access assessment unit 111 may permit all access to the reception device 41, or may perform processing of predetermined different access control.

With respect to the operation from Step 1014 to Step 1015, it will be described further in detail with referring to data shown in FIG. 5 and FIG. 10.

It is supposed that the ID of requester of access control used in the next description is 00004. And, the ID of the reception person is supposed to be 00001.

The reception device 41 can register a plurality of policy 330 with the access control device 12, however, for convenience of description here, it will describe using the first line of the policy 330 of FIG. 10 as the policy 330 which includes the reception person ID. In other words, the policy 330 is as follows.

(a) reception person ID 1121=00001

(b) relationship 1122=subject (this indicates that it is a subject of same photograph.)

(c) provider ID 1123=00010 (in the present exemplary embodiment, it is owner's ID of photograph.)

(d) classification 1124=photograph

(e) access control 1125=call and mail termination permission

(f) trust level 1126=7

The relationship information 320 corresponding to these policies 330 may also be plural, however, for convenience of description, it will describe using information on the first line of the relationship information 320 of FIG. 5 as the relationship information 320. In other words, the relationship information 320 is as follows.

(1) reception person ID 1111=00001

(2) object ID 1112=000001

(3) classification 1113=photograph

(4) requester ID 1114=00004

(5) relationship 1115=subject

(6) provider ID 1116=00010

(7) trust level 1117=7

Further, as it has been already described, the access assessment units 111 according to the present exemplary embodiment does not need to use all data items of the policy 330 shown in FIG. 10. Accordingly, here, a plurality of examples in which the data item used for assessment of the control state of access is different will be described.

Similarly, the access assessment units 111 does not need to use all data items of the relationship information 320 shown in FIG. 5, and the data item related to the assessment may be used.

First, a case where “relationship 1122” is used among the data items of the policy 330 shown in FIG. 10 will be described. In other words, the condition of the policy 330 of this time is “reception person ID 1121=00001, relationship 1122=subject”. This condition is permission to the requester who is a subject of same photograph as the reception person. In other words, the condition of this policy 330 is assessment of whether or not there is the relationship information 320 which includes the reception person and the requester in the relationship information 320 of photograph. Further, because data of the access control 1125 is not used for the condition of the policy 330, the access assessment unit 111 does not assess the contents of access, but assesses permission or non-permission of access (propriety).

In Step 1014, first, the access assessment unit 111 searches for the relationship information 320 which includes the condition of the policy 330 and the requester ID from the relationship storage unit 103.

As it has been already described, the relationship storage unit 103 outputs the information on the first line of FIG. 5 as the relationship information 320.

The reception person ID 1111 of this relationship information 320 is 00001, and the relationship 1115 is the subject. This coincides with the condition of the policy 330 of this time. Further, “00004” of the requester ID of assumed requester of access control coincides with “00004” of the requester ID 1114 of the relationship information 320.

In Step 1015, the access assessment unit 111 assesses as access permission because the received relationship information 320 satisfies the condition of the policy 330 and is the relationship information 320 which includes the requester ID (=00004).

Further, the relationship information 320, for which the access assessment unit 111 searches from the relationship storage unit 103, is not limited to the relationship information 320 which satisfies all conditions (in the present case, it is the photograph in which the reception person and the requester are subjects) used for assessment. For example, the access assessment unit 111 may search for the relationship information 320 which is a part of the condition (for example, an object in which the reception person and the requester are included) from the relationship storage unit 103, and may assess whether or not information which satisfies the remaining condition (the subject of photograph) is included in the received relationship information 320.

Next, a case where the other items of the policy 330 are used will be described. Here, a case where the relationship 1122, the provider ID 1123, the classification 1124 and the access control 1125 are used as the items of the policy 330 will be described. The policy 330 is “reception person ID 1121=00001, relationship 1122=subject, provider ID 1123=00010, classification 1124=photograph and access control 1125=call and mail termination permission”. Among these, the condition of the policy 330 is “reception person ID 1121=00001, relationship 1122=subject, provider ID 1123=00010 and classification 1124=photograph”. And, the content of control target of access to be set as a result of assessment is “access control 1125=call and mail termination permission”.

Further, this policy 330 indicates that the access control device 12 permits termination of a call and a mail to the reception device 41 from the request device 50, when there is the photograph which was provided by the provider (ID=00010), and the reception person (ID=00001) and the requester (ID=00004 in the present case) are appearing as the subjects.

In Step 1014, the access assessment unit 111 searches for the relationship information 320 which satisfies the condition of the policy 330 and includes the requester from the relationship storage unit 103.

The relationship storage unit 103 outputs the information on the first line of FIG. 5 as the relationship information 320.

In Step 1015, the access assessment unit 111 assesses that the requester (ID=00004) agrees with the policy 330 because the received relationship information 320 includes the condition of the policy 330 (reception person ID=00001, relationship=subject, provider ID=00010 and classification=photograph) and also includes the requester ID. As a result, the access assessment unit 111 assesses that it permits the operation designated by the access control, in other words, termination of a call and a mail to the reception device 41 from the request device 50 which the requester uses.

Further, the relationship information 320 for which the access assessment unit 111 searches from the relationship storage unit 103 is not limited to the data which includes all data items. The access assessment unit 111 may receive a part of items to be used for assessment and the corresponding relationship information 320 from the relationship storage unit 103, and may assess whether or not there is the information which coincides with the remaining items in the received relationship information 320.

Next, a case where the relationship 1122 and the trust level 1126 are used as the data items of the policy 330 will be described. In other words, the condition of the policy 330 is “reception person ID 1121=00001, relationship 1122=subject, trust level 1126=7”.

Further, this policy 330 indicates that access is permitted to the requester who has the photograph in which the requester is appearing together with the reception person (ID=00001) as the subjects and the trust level is no smaller than 7.

In Step 1004, the access assessment unit 101 searches for the relationship information 320 which satisfies the condition of the policy 330 and includes the requester from the relationship storage unit 103.

The relationship storage unit 103 outputs the information on the first line of FIG. 5 as the relationship information 320.

As the reception person ID of this relationship information 320 is 00001 and the trust level is 7, the condition of the policy 330 is satisfied. And, “00004” of the requester ID 1114 of the relationship information 320 also coincides with “00004” of the requester ID of the requester of access control.

In Step 1015, the access assessment unit 111 assesses that the requester agrees with the policy 330 because the received relationship information 320 includes the condition of the policy 330 and also includes the requester ID. As a result, the access assessment unit 111 assesses that it permits the access.

In this way, the access assessment unit 111 can determine the control state for access control, without having operation by a reception person, using the policy 330 which the reception person has set and the relationship information 320 which includes relationship.

Operating like this, the access control system 2 performs access control using the policy 330 and the relationship information 320.

Further, operation of the access control system 2 according to the present exemplary embodiment is not limited to the former descriptions.

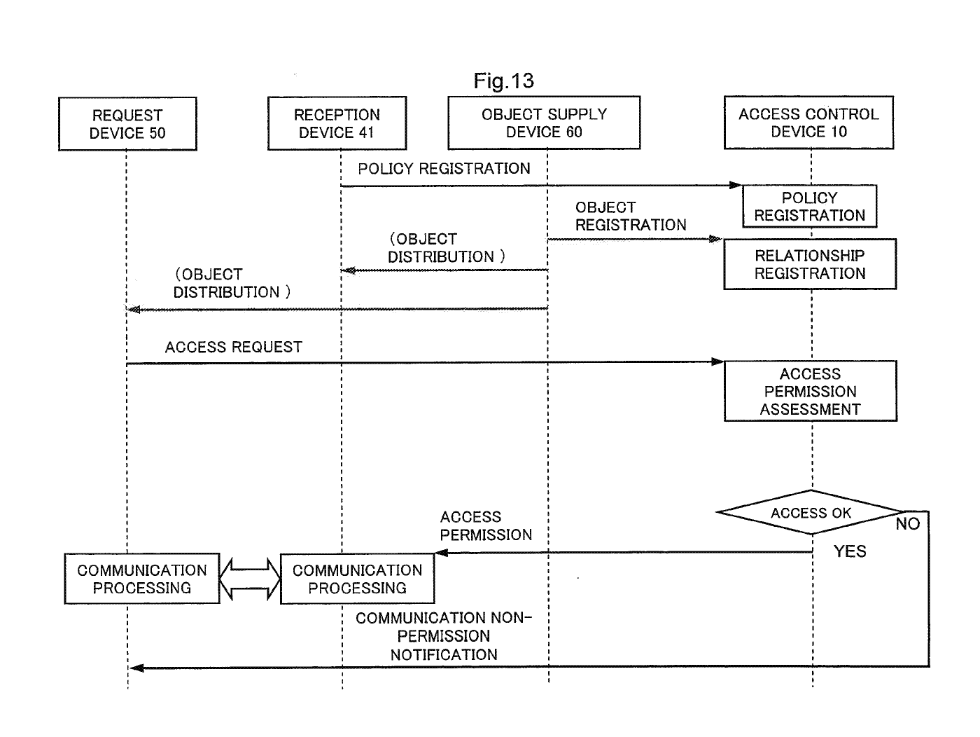

For example, as shown in FIG. 13, when permitting access, the access control device 12 may notify the reception device 41 of access permission, but not notifying the request device 50. In this case, the reception device 41 which has received the notice begins to access the request device 50.

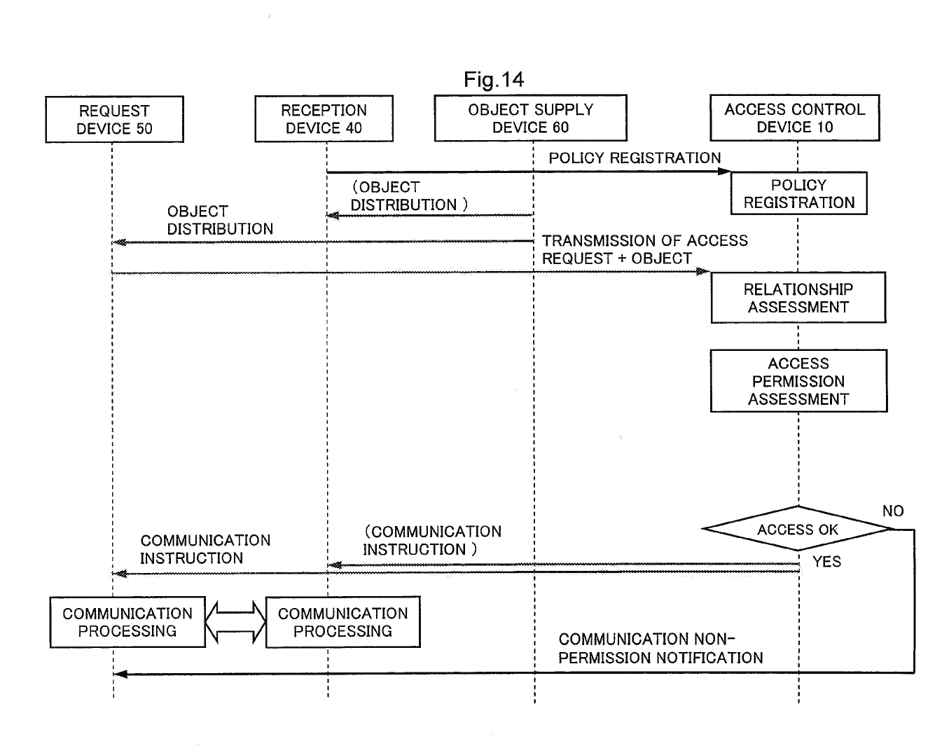

And, as shown in FIG. 14, the access control device 12 may receive “information related to an object” from the request device 50 in addition to the access request, but not receiving “information related to an object” from the object supply device 60.

In this case, the access control device 12 extracts the object information 310 based on “information related to an object” received from the request device 50, similar to the case of receiving from the object supply device 60, and extracts the relationship information 320 from the extracted object information 310. The access control device 12 stores the relationship information 320 and utilizes for assessment of access propriety. However, in order to avoid a possibility of falsification, the access control device 12 sets the trust level of the object information 310 based on a creator of the object.

Operation of access permission assessment after that will be the same operation as the former descriptions.

Further, in order to secure the reliability of the object, the access control device 12 may authenticate, for example using an authentication device which is not illustrated, the received “information related to an object”, and may respond non-permission of access without receiving the object when it cannot be authenticated.

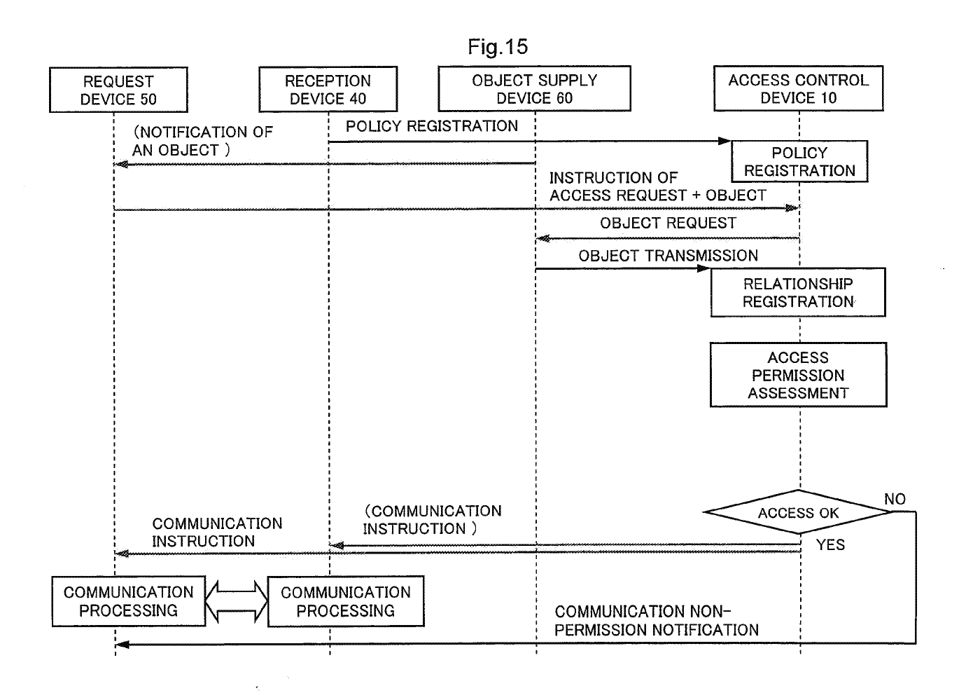

Further, as shown in FIG. 15, the request device 50 may designate the access request and the object supply device 60 which is memorizing “information related to an object” to the access control device 12.

In this case, the request device 50 transmits the information on the access request and the object supply device 60 to the access control device 12.

The access control device 12 which has received this request generates an object request according to the designation, and transmits to the object supply device 60. The object supply device 60 reads out “information related to an object”, which the access control device 12 has designated, from the object storage unit 61 based on the object request, and transmits it to the access control device 12. The operation after this is similar to the sequence shown in FIG. 14. In this way, the access control device 10 may acquire “information related to an object” from the object supply device 60 based on the designation of “information related to an object” from the request device 50.

Thus, the access control device 12 according to the second exemplary embodiment can obtain the effect that performs access control with securing safety, while reducing a burden on a reception person.

The reason is because the access control device 12 performs access control based on the policy 330 which the reception person has set and the relationship information 320 which includes relationship of the requester who has requested the access and the reception person who is an access target. In other words, the access control device 12 secures the safety, based on the use of the policy 330 which the reception person has set, by performing access control along the reception person's policy 330. Further, the access control device 12 uses the relationship information 320 which includes relationship of the reception person and the requester stored in the relationship storage unit 103. Accordingly, without having remote control operation for the access control device 12 and the reception device 41 by a reception person, the access control device 12 can perform assessment of an access requester who agrees with the policy 330 while securing the safety based on the relationship. The reception person may just set the policy 330.

Further, the access control device 12 according to the second exemplary embodiment can control access for each reception person.

The reason is because the policy 330 of the access control device 12 includes the reception person ID that indicates a reception person, and it performs access control based on the reception person ID.

### Third Exemplary Embodiment

The access control device 12 according to the second exemplary embodiment includes a trust level in the object information 310. However, the trust level is not included in the object information 310, but it can be dealt with as another information.

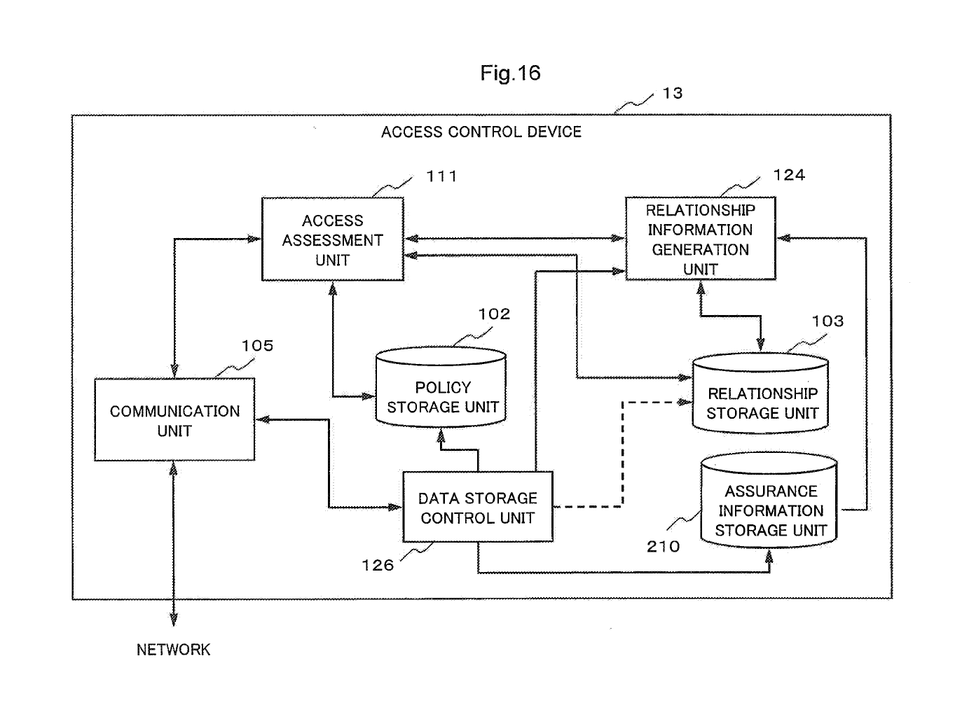

FIG. 16 is a block diagram showing an example of an access control device 13 according to a third exemplary embodiment. In FIG. 16, the same number is assigned to the same configuration as FIG. 9, and the detailed description will be omitted.

The access control device 13 according to the third exemplary embodiment includes a relationship information generation unit 124, a data storage control unit 126 and an assurance information storage unit 210 in addition to the configuration included in the access control device 12 according to the second exemplary embodiment.

In addition to operation of the relationship information generation unit 104 according to the second exemplary embodiment, the relationship information generation unit 124 sets the trust level 1117 of the relationship information 320 based on assurance information 340 which the assurance information storage unit 210 stores.

In addition to operation of the data storage control unit 106 according to the second exemplary embodiment, the data storage control unit 126 receives the assurance information 340 which the assurance information storage unit 210 stores via the communication unit 105, and transfers it to the assurance information storage unit 210.

The assurance information storage unit 210 stores a series of information (hereinafter, referred to as assurance information 340) for judging the trust level of the relationship information 320 which the relationship information generation unit 124 generates based on the object information 310. This assurance information 340, like a policy 330 of a reception person, is sent to the data storage control unit 126 in advance from the reception device 41 or other device which is not illustrated. The data storage control unit 126 stores the assurance information 340 to the assurance information storage unit 210. Further, because the access control device 13 according to the present exemplary embodiment performs uniform management of storing information, the data storage control unit 126 receives the assurance information 340, and transfers it to the assurance information storage unit 210. However, reception of the assurance information 340 is not limited to this. For example, the assurance information storage unit 210 may receive the assurance information 340 via the communication unit 105.

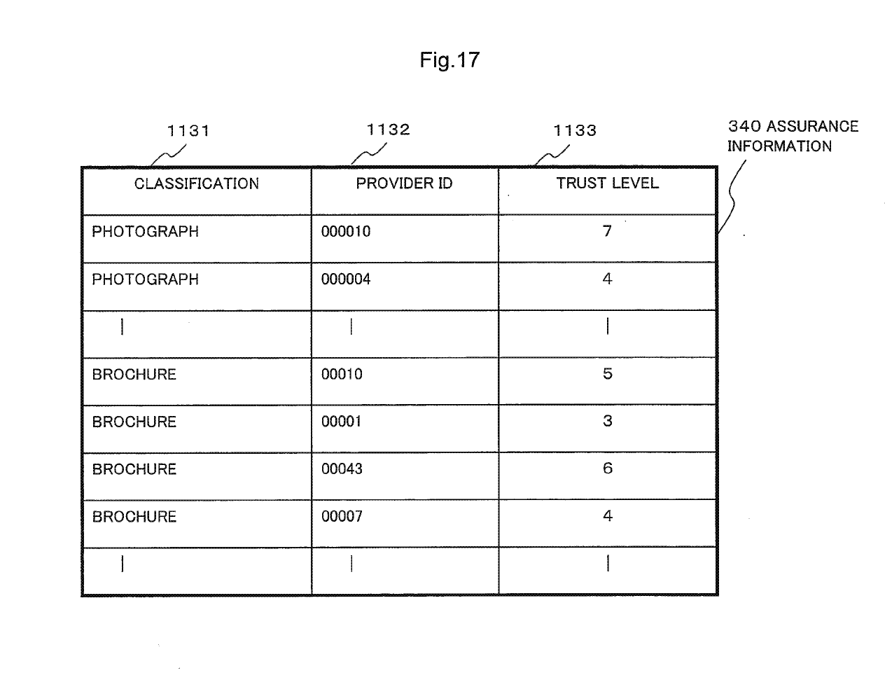

FIG. 17 is a figure showing an example of the assurance information 340 according to the present exemplary embodiment.

In FIG. 17, the assurance information 340 includes classification 1131, provider ID 1132 and trust level 1133.

The classification 1131 indicates classification of the object to which the trust level 1133 is set. The classification 1131 corresponds to the classification 1113 of the relationship information 320.

The provider ID 1132 is an identifier which indicates a provider (or object supply device 60) who has provided the object.

The trust level 1133 is a trust level of the object of the classification 1131 which has received the object from the provider indicated by the provider ID.

For example, when describing about the information on the first line of FIG. 17, it is as follows.

When an object of photograph is provided from the provider ID=00010, the trust level of the object is “7”.

Alternatively, when describing about the information on the fourth line of FIG. 17, it is as follows.

When an object of brochure is provided from the provider ID=00010, the trust level of the object is “5”.

The relationship information generation unit 124 sets the trust level 1117 of the relationship information 320 using the assurance information 340 which the assurance information storage unit 210 stores when it receives the object information 310 from the data storage control unit 126 and makes the relationship information 320.

For example, the relationship information generation unit 124 sets “7” to the trust level of the object of photograph which was provided from the provider ID=00010, and sets “5” to the trust level of the object of brochure which was provided from the provider ID=00010 when it uses the assurance information 340 of FIG. 17 which has been already described.

In this way, the assurance information 340 of the object according to the present exemplary embodiment can set a different value to the object of the same provider based on the classification of the object.

Further, although the assurance information 340 according to the present exemplary embodiment is set the trust level based on the provider of object and the classification, it is not limited to this. The assurance information 340 according to the present exemplary embodiment may be set the trust level based on the other attributes of the object, for example, relationship, storage date and time, storage term, storage medium or route of acquisition.

And, the access control device 13 according to the present exemplary embodiment does not use the trust level 1105 of the object information 310 which the relationship storage unit 103 stores because it uses the assurance information 340 of the assurance information storage unit 210. Accordingly, the object information 310 according to the present exemplary embodiment may not need to include the trust level 1105.

In this way, the access control device 13 according to the present exemplary embodiment does not perform access control evenly based on the object, but can set the trust level based on the assurance information 340 based on the attribute of the object.

Thus, the access control device 13 according to the third exemplary embodiment can obtain the effect that can more finely control access in addition to the effect according to the second exemplary embodiment.

The reason is that the access control device 13 according to the third exemplary embodiment stores the assurance information 340 which is based on the attribute (provider and classification) of object apart from the object, and sets the trust level of the relationship information 320 based on the assurance information 340. Accordingly, it is because the access control device 13 can set a plurality of trust levels to the relationship information 320 with respect to the attribute (for example, provider) of object.

### Fourth Exemplary Embodiment

The access control device 12 according to the second exemplary embodiment notified the request device 50 of an address of the reception device 41 when it permits access. However, the access control device 12 can secure the safety of communication of the reception device 41 using a temporary address, not a true address of the reception device 41, as an address to be provided to the request device 50.

Further, “temporary address (address)” is an address which is different from the true address of the reception device 41, and is an address used temporarily as an access destination of the reception device 41 from the request device 50. The reception device 41 can communicate with the request device 50 using “temporary address” without disclosing the true address until it trusts the request device 50.

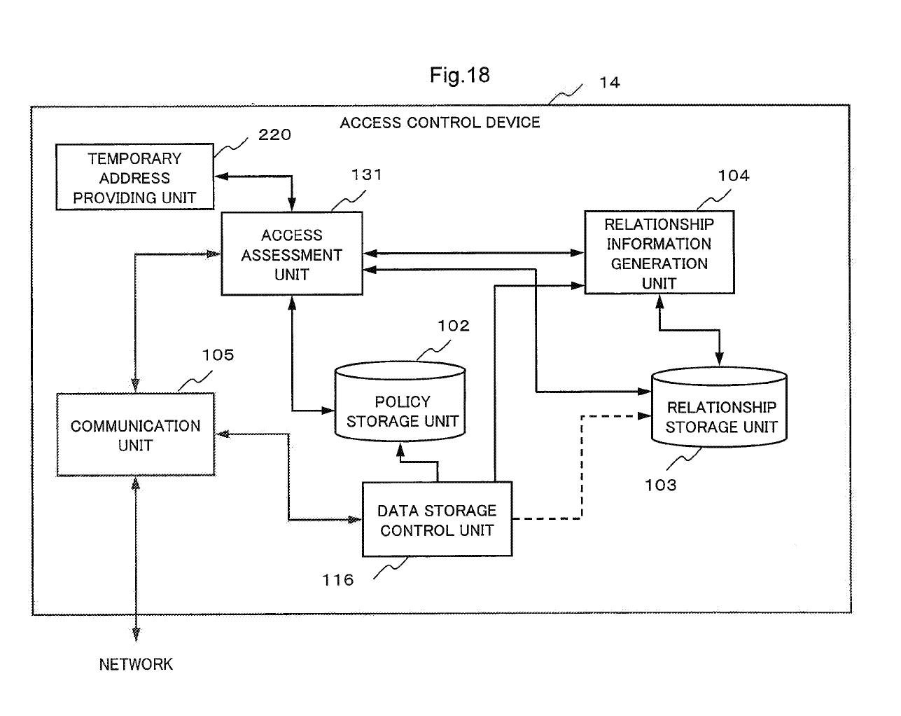

FIG. 18 is a block diagram showing an example of an access control device 14 according to a fourth exemplary embodiment. In FIG. 18, the same number is assigned to the same configuration as FIG. 9, and the detailed description will be omitted.

The access control device 14 according to the fourth exemplary embodiment includes an access assessment unit 131 and a temporary address providing unit 220 in addition to the configuration included in the access control device 12 according to the second exemplary embodiment.

The access assessment unit 131 deals with a temporary address which will be described later in addition to operation of the access assessment unit 111 according to the second exemplary embodiment.

The temporary address providing unit 220 provides a temporary address used for the reception device 41.

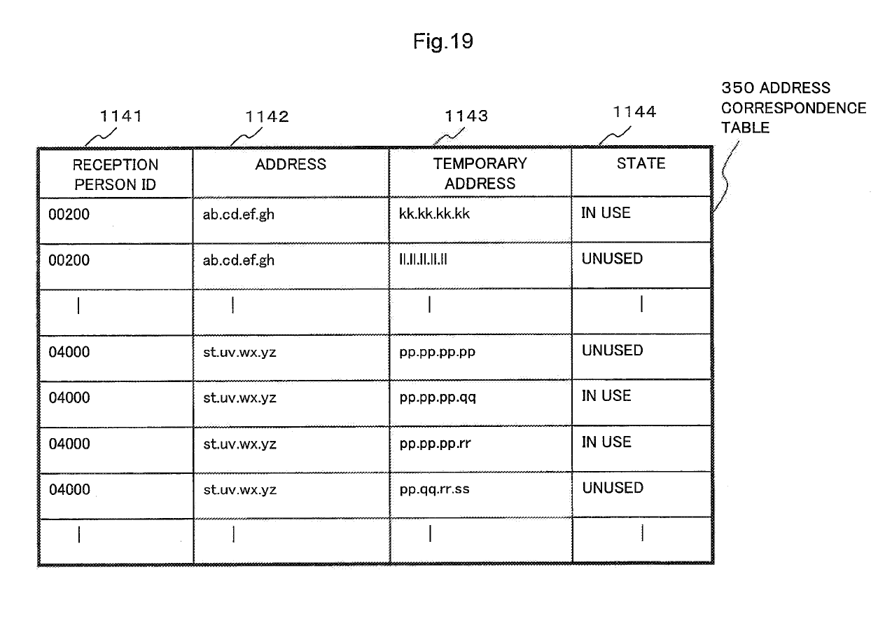

FIG. 19 is a figure showing an example of an address correspondence table 350 which the temporary address providing unit 220 according to the present exemplary embodiment holds.

The address correspondence table 350 includes reception person ID 1141, address 1142, temporary address 1143 and state 1144.

The reception person ID 1141 is an identifier of a reception person. Further, as it has been already described, the reception person ID is also an identifier of the reception device 41 in the present exemplary embodiment.

The address 1142 indicates a true address of the reception device 41. Further, although not shown in FIG. 19, the reception device 41 according to the present exemplary embodiment may be provided with a plurality of true addresses.

The temporary address 1143 is a temporary address used for presenting to the request device 50. The access control device 14 according to the present exemplary embodiment has one or more temporary addresses to one device.

The state 1144 indicates a usage state of the temporary address 1143. The access control device 14 according to the present exemplary embodiment can use the same temporary address 1143 to a plurality of request devices 50. However, the access control device 14 according to the present exemplary embodiment uses the temporary address 1143 of unused state as the temporary address 1143 for newly notifying the request device 50, and manages it for each request device 50.

In this way, the access control device 14 provided with the temporary address providing unit 220 controls access using the same operation as the operation shown in FIG. 12 after it receives the access request. Then, the access assessment unit 131 of the access control device 14 extracts the temporary address 1143 of unused state from the temporary address providing unit 220 based on the reception person ID 1141 and the state 1144 of the reception device 41 when it permits access in Step 1016. Further, the access assessment unit 131 transmits notification of access permission and the temporary addressing of the reception device 41 to the request device 50. At that time, the access control device 14 may notify the reception device 41 of information about the temporary address of which notified the request device 50, and the request device 50 which uses the temporary address.

After notifying of the temporary address, the access control device 14 sets the state 1144 of the notified temporary address 1143 being in use.

The request device 50 accesses the reception device 41 using the received temporary address.

After starting access, the reception device 41 transmits a true address to the request device 50 and communicates using the true address, when it judges that access with the request device 50 is safe.

On the other hand, the reception device 41 cancels the access using the temporary address when it judges that there is a problem in the access with the request device 50. Further, the reception device 41 may request the access control device 13 cancellation of use of the used temporary address. Based on such operation, the reception device 41 becomes not to receive the access using the temporary address of which notified the request device 50.

Further, the access control device 14, which has received the notification of commencement of use of the true address or cancellation of use of the temporary address from the reception device 41, restores the state 1144 of the temporary address 1143 to unused.

Thus, the access control device 14 according to the fourth exemplary embodiment can obtain the effect that improves the safety of the reception device 41 in addition to the effect according to the first exemplary embodiment.

The reason is because the access control device 14 according to the fourth exemplary embodiment notifies the request device 50 of the temporary address of the reception device 41, and can hide the address of the reception device 41 from the request device 50. Accordingly, the reception device 41 can prevent the address from being known by a wrong request device 50.

### Fifth Exemplary Embodiment

The access control device 12 according to the second exemplary embodiment controls access about the reception device 41 which the request device 50 requests by the access request.

The request device 50 does not know a reception device 41 which is accessible in advance. Accordingly, the access request of the request device 50 may become non-permission. However, if the request device 50 can know accessible reception devices 41 before the access request, it selects a reception device 41 for the access request among them, and can avoid the access request being refused.

An access control device 15 according to a fifth exemplary embodiment notifies the request device 50 of the accessible reception device 41.

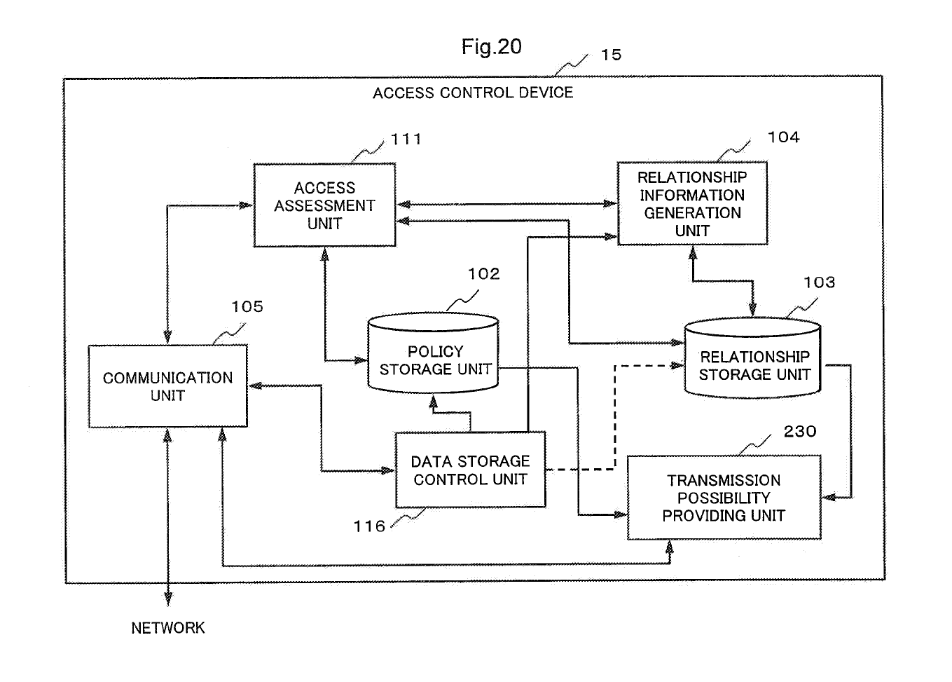

FIG. 20 is a block diagram showing an example of the access control device 15 according to a fifth exemplary embodiment. In FIG. 20, the same number is assigned to the same configuration as FIG. 9, and the detailed description will be omitted.

The access control device 15 according to the fifth exemplary embodiment includes a transmission possibility providing unit 230 in addition to the configuration included in the access control device 12 according to the second exemplary embodiment.

The transmission possibility providing unit 230 extracts the accessible reception device 41 when it receives a request of extraction of accessible reception device 41 from the request device 50 via the communication unit 105. The transmission possibility providing unit 230 uses the relationship information 320 and the policy 330 for extraction of the reception device 41.

Next, operation of the transmission possibility providing unit 230 will be described.

The transmission possibility providing unit 230 of the access control device 15, which receives a confirmation request of the reception device 41 which is possible for transmission from a requester (or request device 50) via the communication unit 105, extracts information including the requester ID from the relationship information 320.

For example, the transmission possibility providing unit 230 which has received the request from requester ID=00004 extracts the first line of the relationship information 320 shown in FIG. 5.

Next, the transmission possibility providing unit 230 assesses whether or not there is the policy 330 conforming to the extracted relationship information 320. However, the assessment of conformity of the transmission possibility providing unit 230 is the assessment of the condition of access control. Accordingly, the control state of access (for example, access control 1125 in FIG. 10) of the policy 330 is not included in the assessment item here. And, requester ID 1114 is also not subject to the assessment because there is no requester ID in the policy 330.

As an example of this conformity, it is as follows referring to FIG. 5 and FIG. 10. For example, in case of the example of above, the first line of the relationship information 320 of FIG. 5 is extracted. The transmission possibility providing unit 230 assesses whether or not there is the policy 330 which can satisfy the relationship information 320 on the first line of FIG. 5 in the policy 330 shown in FIG. 10. In the present case, the first line of the policy 330 is “reception person ID=00001, relationship=subject, provider ID=00010, classification=photograph, trust level=7”, and conforms to the first line of the relationship information 320 of FIG. 5.

Therefore, the transmission possibility providing unit 230 assesses that the reception person (ID=00001) permits termination of a call or a mail from the requester (ID=00004), in other words, transmission is possible.

After assessment, the transmission possibility providing unit 230 notifies the requester (or request device 50) of information about the reception device 41 (ID=00001 in the present case) to which transmission is possible via the communication unit 105.

The request device 50 which has received this notification processes predetermined operation. For example, the request device 50 may make a display, which is not illustrated, display the information relating to the reception device 41, and may receive a request of access request from the requester.

Further, in the description of the present exemplary embodiment, it has described a case where the reception device 41 is one, however, this is for convenience of description. The present exemplary embodiment may include a plurality of reception devices 41.

Thus, the access control device 15 according to the fifth exemplary embodiment can obtain the effect that the request device 50 knows the accessible reception device 41 in addition to the effect according to the second exemplary embodiment.

This reason is because the access control device 15 according to the fifth exemplary embodiment acquires the reception device 41 to which the request device 50 is accessible based on the relationship information 320 and the policy 330, and notifies the request device 50 of this result.

### Sixth Exemplary Embodiment

The access control system 2 according to the second exemplary embodiment controls a connection of the request device 50 and the reception device 41.

However, the access control device 12 can use the assessment result of access for control of the other device.

An access control device 16 of an access control system 3 according to a sixth exemplary embodiment controls a communication service device 20 which performs communication services via the network 30.

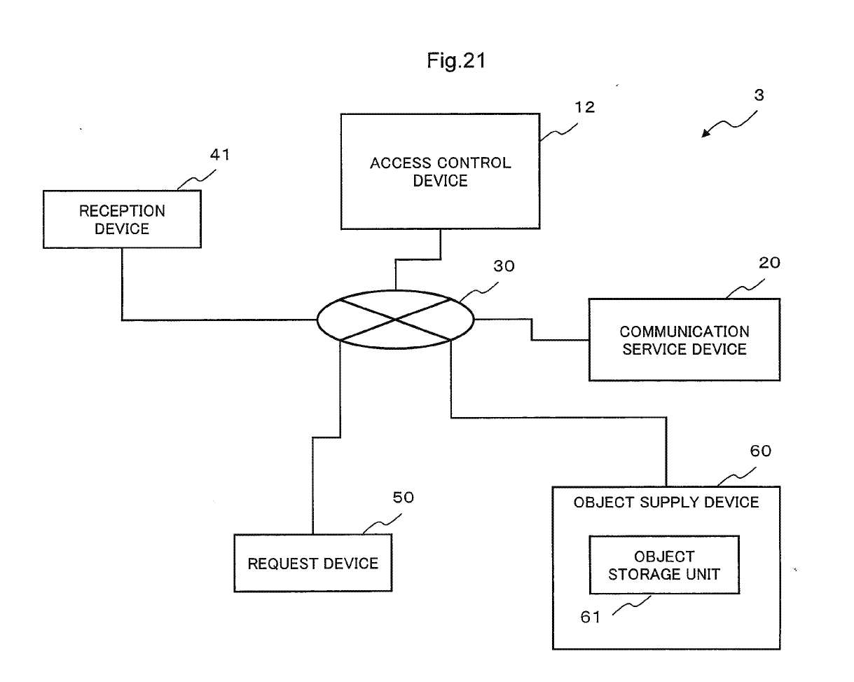

FIG. 21 is a block diagram showing an example of the access control system 3 according to the sixth exemplary embodiment. In FIG. 21, the same number is assigned to the same configuration as FIG. 8, and the detailed description will be omitted.

Further, the access control device 16 and the communication service device 20 may connect not via the network 30, for example, directly connect, however, the present exemplary embodiment will describe a case of connecting via the network 30.

The communication service device 20 provides communication services via the network 30 based on the assessment of access control of the access control device 16.

The communication service device 20 can correspond with various communication services. Here, as an example of the communication service, a case where the communication service device 20 manages V-LAN (Virtual Local Area Network) using the network 30 will be described.

The communication service device 20 manages the V-LAN established in the network 30, specifically, manages (addition, deletion, or the like) the devices which participate in the V-LAN according to directions of the access control device 16.

Here, it is supposed that the reception device 41 is the device which has already participated in the V-LAN.

The request device 50 needs to participate in the V-LAN in order to access the reception device 41. Therefore, the request device 50 transmits a participation request (access request) in the V-LAN to the access control device 16.

The access control device 16 which has received the access request assesses permission or non-permission (permission/non-permission: access propriety) of access using the policy 330 and the relationship information 320 which have been already described in the second exemplary embodiment.

When the assessment is non-permission, the access control device 16, similar to the second exemplary embodiment, transmits the notification of access non-permission to the request device 50.

When the assessment is permission, the access control device 16 notifies the communication service device 20 to make the request device 50 participate in the V-LAN.

The communication service device 20 which has received this notice changes setting of V-LAN so that the request device 50 can connect to the V-LAN, and after the change, notifies the request device 50 of participation permission in the V-LAN.

The request device 50 which has received this permission notice accesses the reception device 41 using the participated V-LAN.

Further, the communication service device 20 does not need to be a separated device from the access control device 16, and they may be configured by one device.

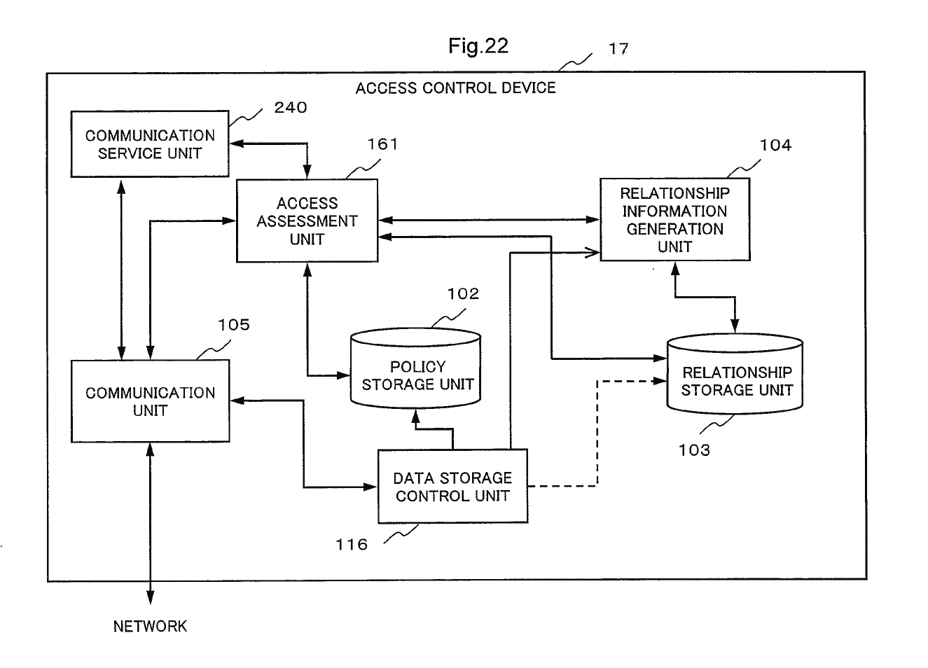

FIG. 22 is a block diagram showing an example of an access control device 17 in which the access control device 16 and the communication service device 20 are included as one device. In FIG. 22, the same number is assigned to the same configuration as FIG. 9, and the detailed description will be omitted.

An access assessment unit 161 sends information about access control to the communication service unit 240 in addition to the same operation as the access assessment unit 111 according to the second exemplary embodiment.

A communication service unit 240 receives the information about access control from the access assessment unit 161, and operates similar to the communication service device 20 via the communication unit 105.

Thus, the access control system 3 (and the access control device 17) according to the sixth exemplary embodiment can reduce a burden on owner of the reception device 41 also in the control of communication services in the network 30 in addition to the effect according to the first exemplary embodiment.

The reason is because the access control system 3 (and the access control device 17) according to the sixth exemplary embodiment controls the communication service device 20 (and the communication service unit 240) using the policy 330 and the relationship information 320. As a result, it is because the access control system 3 (and the access control device 17) can control communication services in which a burden on the owner is reduced using the relationship information 320 while it secures the safety along the policy 330 of owner of the reception device 41.

The whole or part of the present exemplary embodiment disclosed above can be described as, but not limited to, the following supplementary notes.

(Supplementary Notes)

(Supplementary Note 1)

An access control device including:

a relationship information generation unit which generates relationship information, based on object information relating to a first user and the object information relating to a second user, including relationship between said users;

a relationship storage unit which stores said relationship information; and

an access assessment unit which assesses a control state of access requested to said second user from said first user based on said relationship information which said relationship storage unit stores.

(Supplementary Note 2)

The access control device according to supplementary note 1, wherein

said access assessment unit assesses access propriety based on whether or not said relationship information including said first user and said second user is stored in said relationship storage unit.

(Supplementary Note 3)

The access control device according to supplementary note 2, wherein

said access assessment unit assesses the control state of access further based on relationship between said first user and said second user included in said relationship information.

(Supplementary Note 4)

The access control device according to any one of supplementary note 1 to supplementary note 3, wherein

said relationship information generation unit generates said relationship information including a trust level that indicates degree of trust of a provider, who has provided said object information, to the second user, and

said access assessment unit assesses the control state of access based on said trust level.

(Supplementary Note 5)

The access control device according to any one of supplementary note 1 to supplementary note 4, wherein

said relationship information generation unit generates said relationship information including the provider of said object information, and

said access assessment unit assesses the control state of access based on said provider.

(Supplementary Note 6)

The access control device according to any one of supplementary note 1 to supplementary note 5, wherein

said relationship information generation unit generates said relationship information including classification of said object information, and

said access assessment unit assesses the control state of access based on said classification.

(Supplementary Note 7)

The access control device according to any one of supplementary note 1 to supplementary note 6, further including:

a policy storage unit which stores a policy of access including relationship with said second user, and wherein

said access assessment unit extracts said relationship information including relationship between said first user, who conforms to the relationship with said second user included in said policy, and said second user, and assesses the control state of access based on said relationship information which is extracted.

(Supplementary Note 8)

The access control device according to any one of supplementary note 1 to supplementary note 7, further including:

a temporary address providing unit which provides a temporary address used for access to said second user, and wherein

said access assessment unit uses said temporary address for the control state of access.

(Supplementary Note 9)

The access control device according to any one of supplementary note 7 to supplementary note 8, further including:

a transmission possibility providing unit which assesses said second user, to whom permission of access is possible when said first user has requested the access, based on said policy and said relationship information.

(Supplementary Note 10)

The access control device according to any one of supplementary note 1 to supplementary note 9, including:

a communication service unit which controls communication services of a network based on an assessment result of said access assessment unit.

(Supplementary Note 11)

An access control system including:

the access control device according to any one of supplementary note 1 to supplementary note 10;

a reception device which is subject to a request of access and operated by said second user;

a request device which transmits the request of access of said first user;

a reception device which is subject to access to the second user requested from said first user; and

a network which connects said each device.

(Supplementary Note 12)

The access control system according to Supplementary note 11, further comprising:

a communication service device which controls communication services based on a result of assessment of access of said access control device.

(Supplementary Note 13)

An access control method including:

generating relationship information, based on object information relating to a first user and the object information relating to a second user, including relationship between said users; and

assessing a control state of access requested to said second user from said first user based on said relationship information.

(Supplementary Note 14)

An access control program which causes a computer to execute processing including:

processing which generates relationship information, based on object information relating to a first user and the object information relating to a second user, including relationship between said users; and

processing which assesses a control state of access requested to said second user from said first user based on said relationship information.

This application is based upon and claims the benefit of priority from Japanese patent application No. 2010-224508, filed on Oct. 15, 2010, the disclosure of which is incorporated herein in its entirety by reference.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### DESCRIPTION OF SYMBOL

1 Access control system
2 Access control system
3 Access control system
10 Access control device
11 Access control device
12 Access control device
13 Access control device
14 Access control device
15 Access control device
16 Access control device
17 Access control device
20 Communication service device
30 Network
40 Reception device
41 Reception device
50 Request device
60 Object supply device
61 Object storage unit
101 Access assessment unit
102 Policy storage unit
103 Relationship storage unit
104 Relationship information generation unit
105 Communication unit
106 Data storage control unit
111 Access assessment unit
116 Data storage control unit
124 Relationship information generation unit
126 Data storage control unit
131 Access assessment unit
161 Access assessment unit
210 Assurance information storage unit
220 Temporary address providing unit
230 Transmission possibility providing unit
240 Communication service unit
310 Object information
320 Relationship information
330 Policy
340 Assurance information
350 Address correspondence table

1. An access control device comprising:
a relationship information generation unit which generates relationship information, based on object information relating to an object which is prescribed electronic data of a first user and the object information relating to an object which is prescribed electronic data of a second user, including relationship between said users;
a relationship storage unit which stores said relationship information; and
an access assessment unit which assesses a control state of access requested to said second user from said first user based on said relationship information which said relationship storage unit stores.

2. The access control device according to claim 1, wherein
said access assessment unit assesses access propriety based on whether or not said relationship information including said first user and said second user is stored in said relationship storage unit.

3. The access control device according to claim 2, wherein
said access assessment unit assesses the control state of access further based on relationship between said first user and said second user included in said relationship information.

4. The access control device according to claim 1, wherein
said relationship information generation unit generates said relationship information including a trust level that indicates degree of trust of a provider, who has provided said object, to the second user, and
said access assessment unit assesses the control state of access based on said trust level.

5. The access control device according to claim 1, wherein
said relationship information generation unit generates said relationship information including the provider of said object, and
said access assessment unit assesses the control state of access based on said provider.

6. The access control device according to claim 1, wherein
said relationship information generation unit generates said relationship information including classification of said object, and
said access assessment unit assesses the control state of access based on said classification.

7. The access control device according to claim 1, further comprising:
a policy storage unit which stores a policy of access including relationship with said second user, and wherein
said access assessment unit extracts said relationship information including relationship between said first user, who conforms to the relationship with said second user included in said policy, and said second user, and assesses the control state of access based on said relationship information which is extracted.

8. The access control device according to claim 1, further comprising:
a temporary address providing unit which provides a temporary address used for access to said second user, and wherein
said access assessment unit uses said temporary address for the control state of access.

9. The access control device according to claim 7, further comprising:
a transmission possibility providing unit which assesses said second user, to whom permission of access is possible when said first user has requested the access, based on said policy and said relationship information.

10. The access control device according to claim 1, comprising:
a communication service unit which controls communication services of a network based on an assessment result of said access assessment unit.

11. An access control system comprising:
the access control device according to claim 1;
a reception device which is subject to a request of access and operated by said second user;
a request device which transmits the request of access of said first user;
a reception device which is subject to access to the second user requested from said first user; and
a network which connects said each device.

12. The access control system according to claim 11, further comprising:
a communication service device which controls communication services based on a result of assessment of access of said access control device.

13. An access control method comprising:
generating relationship information, based on object information relating to an object which is prescribed electronic data of a first user and the object information relating to an object which is prescribed electronic data of a second user, including relationship between said users; and
assessing a control state of access requested to said second user from said first user based on said relationship information.

14. A computer readable medium embodying a program, said program causing an access control device to perform a method, said method comprising:
generating relationship information, based on object information relating to an object which is prescribed electronic data of a first user and the object information relating to an object which is prescribed electronic data of a second user, including relationship between said users; and
assessing a control state of access requested to said second user from said first user based on said relationship information.

15. An access control device comprising:
a relationship information generation means for generating relationship information, based on object information relating to an object which is prescribed electronic data of a first user and the object information relating to an object which is prescribed electronic data of a second user, including relationship between said users;
a relationship storage means for storing said relationship information; and
an access assessment means for assessing a control state of access requested to said second user from said first user based on said relationship information which said relationship storage means stores.
